(19) United States
(12) Patent Application Publication
(10) Pub. No.: US 2025/0158802 A1
(43) Pub. Date: May 15, 2025

(54) PRIVACY-PRESERVING NEURAL NETWORK MODEL AND PRIVACY-PRESERVING PREDICTION USING THE PRIVACY-PRESERVING NEURAL NETWORK MODEL

(71) Applicant: NANYANG TECHNOLOGICAL UNIVERSITY, Singapore (SG)

(72) Inventors: Kwok Yan LAM, Singapore (SG); Huaxiong WANG, Singapore (SG); Xianhui LU, Singapore (SG); Linru ZHANG, Singapore (SG); Xiangning WANG, Singapore (SG)

(21) Appl. No.: 18/839,497

(22) PCT Filed: Feb. 15, 2023
(86) PCT No.: PCT/SG2023/050085

§ 371 Date: Aug. 19, 2024

(30) Foreign Application Priority Data
Feb. 24, 2022 (SG) 10202201824W
May 13, 2022 (SG) 10202205037W

(51) Int. Cl. H04L 9/00; G06N 3/0464

(52) U.S. Cl. CPC H04L 9/008; G06N 3/0464

(57) ABSTRACT

A method of building a privacy-preserving neural network model is provided. The method includes: performing first neural network operations using a non-private neural network of the privacy-preserving neural network model based on first input data in plaintext to produce first output data in plaintext, whereby the non-private neural network is pre-trained and learnable parameters of the non-private neural network are fixed while performing the first neural network operations; encrypting the first output data from the non-private neural network using a homomorphic encryption method to produce first encrypted data; and performing second neural network operations homomorphically using a private neural network of the privacy-preserving neural network model based on the first encrypted data to produce second encrypted data, whereby learnable parameters of the private neural network are trained while performing the second neural network operations. There is also provided a corresponding system for building a privacy-preserving neural network model, as well as method and system for performing privacy-preserving prediction using the privacy-preserving neural network model built.

### CROSS-REFERENCE TO RELATED APPLICATION

This application claims the benefit of priority of Singapore Patent Application No. 10202201824 W filed on 24 Feb. 2022 and Singapore Patent Application No. 10202205037 W filed on 13 May 2022, the contents of which being hereby incorporated by reference in their entirety for all purposes.

### TECHNICAL FIELD

The present invention generally relates to a method and a system for building a privacy-preserving neural network model, and a method and a system for performing privacy-preserving prediction using a privacy-preserving neural network model, such as the privacy-preserving neural network model built.

### BACKGROUND

Privacy issues in machine learning service caught many people's attention. Machine learning algorithms are usually cloud-based. Users may upload their input data (e.g., query) to a cloud server and wait for a prediction output in response thereto. In this regard, the input data may have sensitive information (e.g., medical report), and the prediction output may be confidential. Therefore, users may wish to send their input data in an encrypted form to a cloud service which offers privacy-preserving predictions and returns encrypted prediction outputs to the users. Accordingly, privacy-preserving technologies are gaining more and more importance in view of the rapid development of data research and cloud computation. In this regard, homomorphic encryption (e.g., fully homomorphic encryption (FHE)) is a powerful tool to protect users' privacy. For example, according to a FHE method (or scheme), all computations (or calculations) are performed in the form of ciphertext, without any decryption involved. For example, an example data flow may be as follows: 1) user encrypts the data and sends the ciphertext to an algorithm holder; 2) the algorithm holder performs computations on the ciphertext using the algorithm and returns an output to user, which is also a ciphertext; and 3) the user decrypts the output. During this process, the algorithm holder only observes the ciphertext of user's data, and by the provable security of the homomorphic encryption scheme, no extra information is leaked which ensures the privacy of user.

Accordingly, homomorphic encryption is a useful tool in privacy-preserving neural networks. For example, FIG. 1 depicts a schematic drawing of a basic privacy-preserving neural network model. With the help of homomorphic encryption, the cloud server can perform computations (or calculations) of the neural network homomorphically on encrypted input data from a user (which may also be referred to as a client) and return a ciphertext comprising the prediction output to the user. However, homomorphic computations on encrypted data is much slower than computations on plaintext, especially for computations of non-linear functions (e.g., activation function in neural network). Therefore, practical applications in real world of such a basic privacy-preserving neural network model are very limited. For example, only very simple task (such as recognition of hand-written numbers) may be performed using such a basic privacy-preserving neural network model. Furthermore, most existing homomorphic encryption schemes are not designed or optimized for privacy-preserving neural network, which is another factor in causing poor performance.

Accordingly, existing works around privacy-preserving neural network do not perform well. For example, some works may be fast, but only support very simple activation functions (e.g., square function and sign function), which is rarely used in real or practical neural networks. On the other hand, other works may support many kinds of activation functions but are not optimized for neural networks, so they are slow and inaccurate. In addition, existing works only consider the basic privacy-preserving neural network model such as illustrated in FIG. 1, whose practical application is very limited due to poor performances.

A need therefore exists to provide a method and a system for building a privacy-preserving neural network model, and a method and a system for performing privacy-preserving prediction, that seek to overcome, or at least ameliorate, one or more deficiencies in conventional privacy-preserving neural network models and conventional methods and systems for performing privacy-preserving prediction, and more particularly, to improve efficiency (e.g., improving speed) and/or effectiveness (e.g., protecting privacy, enhancing practical applications and/or enhancing prediction accuracy). It is against this background that the present invention has been developed.

### SUMMARY

According to a first aspect of the present invention, there is provided a method of building a privacy-preserving neural network model using at least one processor, the method comprising:
performing first neural network operations using a non-private neural network of the privacy-preserving neural network model based on first input data in plaintext to produce first output data in plaintext, wherein the non-private neural network is pre-trained and learnable parameters of the non-private neural network are fixed while performing the first neural network operations;
encrypting the first output data from the non-private neural network using a homomorphic encryption method to produce first encrypted data; and
performing second neural network operations homomorphically using a private neural network of the privacy-preserving neural network model based on the first encrypted data to produce second encrypted data, wherein learnable parameters of the private neural network are trained while performing the second neural network operations.

According to a second aspect of the present invention, there is provided a system for building a privacy-preserving neural network model, the system comprising:
at least one memory; and
at least one processor communicatively coupled to the at least one memory and configured to perform the method of building a privacy-preserving neural network model according to the above-mentioned first aspect of the present invention.

According to a third aspect of the present invention, there is provided a computer program product, embodied in one or more non-transitory computer-readable storage mediums, comprising instructions executable by at least one processor to perform the method of building a privacy-preserving neural network model according to the above-mentioned first aspect of the present invention.

According to a fourth aspect of the present invention, there is provided a method of performing privacy-preserving prediction using a privacy-preserving neural network model, the method comprising:
performing, at a first system, first neural network operations using a non-private neural network of the privacy-preserving neural network model based on first input data in plaintext to produce first output data in plaintext;
encrypting, at the first system, the first output data from the non-private neural network using a homomorphic encryption method to produce first encrypted data; and
performing, at a second system, second neural network operations homomorphically using a private neural network of the privacy-preserving neural network model based on the first encrypted data transmitted from the first system and received by the second system to produce second encrypted data corresponding to an encrypted prediction result with respect to the first input data.

According to a fifth aspect of the present invention, there is provided a system for performing privacy-preserving prediction using a privacy-preserving neural network model, the system comprising:
a first system comprising:
   at least one memory; and
   at least one processor communicatively coupled to the at least one memory and configured to perform said first neural network operations and said encrypting the first output data of the method of performing privacy-preserving prediction according to the above-mentioned fourth aspect of the present invention; and
a second system comprising:
   at least one memory; and
   at least one processor communicatively coupled to the at least one memory and configured to perform said second neural network operations homomorphically of the method of performing privacy-preserving prediction according to the above-mentioned fourth aspect of the present invention.

According to a sixth aspect of the present invention, there is provided a computer program product, embodied in one or more non-transitory computer-readable storage mediums, comprising instructions executable by at least one processor to perform the method of performing privacy-preserving prediction according to the above-mentioned fourth aspect of the present invention.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIG. 1 depicts a schematic drawing of a basic privacy-preserving neural network model;

FIG. 2 depicts a schematic flow diagram of a method of building a privacy-preserving neural network model, according to various embodiments of the present invention;

FIG. 3 depicts a schematic flow diagram of a method of performing privacy-preserving prediction using a privacy-preserving neural network model, according to various embodiments of the present invention

FIG. 4 depicts a schematic block diagram of a system for building a privacy-preserving neural network model, according to various embodiments of the present invention;

FIG. 5 depicts a schematic block diagram of a system for performing privacy-preserving prediction using a privacy-preserving neural network model, according to various embodiments of the present invention;

FIG. 6 depicts a schematic block diagram of an exemplary computer system in which the system shown in FIG. 4, the first system shown in FIG. 5 or the second system shown in FIG. 5, according to various embodiments of the present invention, may be realized or implemented;

FIG. 7 depicts a schematic drawing of a hybrid privacy-preserving neural network model, according to various example embodiments of the present invention;

FIG. 8 depicts a schematic diagram illustrating a first example hybrid model building method, along with an example network structure of the corresponding first example hybrid model built, according to various example embodiments of the present invention;

FIG. 9 depicts a schematic diagram illustrating a second example hybrid model building method, along with an example network structure of the corresponding second example hybrid model built, according to various example embodiments of the present invention;

FIG. 10 depicts a graph illustrating a general approach for selecting a model building method based on two factors, according to various example embodiments of the present invention;

FIG. 11 depicts a graph illustrating a general approach for selecting or determining a FHE scheme for the private neural network based on the structure of the private neural network, according to various example embodiments of the present invention;

FIG. 12 depicts a schematic flow diagram showing a summary for (1) determining the model building (or training) method, (2) the private network structure and (3) the FHE scheme for the private network, according to various example embodiments of the present invention;

FIG. 13 depicts a schematic diagram of neural network operations performed at a node of a layer in a neural network, according to various example embodiments of the present invention;

FIG. 14 shows an example algorithm (Algorithm 1) for a LWE encryption scheme, according to various example embodiments of the present invention;

FIG. 15 shows an example algorithm (Algorithm 2) for scale multiplication, according to various example embodiments of the present invention;

FIG. 16 shows an example algorithm (Algorithm 3) for addition, according to various example embodiments of the present invention;

FIG. 17 shows an example algorithm (Algorithm 4) for a RLWE encryption scheme, according to various example embodiments of the present invention;

FIG. 18 shows an example algorithm (Algorithm 5) for an extended RLWE encryption scheme, according to various example embodiments of the present invention;

FIG. 19 shows an example algorithm (Algorithm 6) for extended RLWE ciphertext multiplication (⋄), according to various example embodiments of the present invention;

FIG. 20 shows an example algorithm (Algorithm 7) for RGSW encryption based on extended RLWE encryption, according to various example embodiments of the present invention;

FIG. 21 shows an example algorithm (Algorithm 8) for RLWE and RGSW multiplication (⊙), according to various example embodiments of the present invention;

FIG. 22 shows an example algorithm (Algorithm 9) for an extract operation, according to various example embodiments of the present invention;

FIG. 23 shows an example algorithm (Algorithm 10) for LWE rounding and rescale operation, according to various example embodiments of the present invention;

FIG. 24 shows an example algorithm (Algorithm 11) for LWE key switch operation, according to various example embodiments of the present invention;

FIG. 25 shows an example algorithm (Algorithm 12) for a bit-by-bit LUT evaluation, according to various example embodiments of the present invention;

FIG. 26 shows an example algorithm (Algorithm 13) for a 2-bit LUT evaluation for single hidden layer, according to various example embodiments of the present invention;

FIG. 27 shows an example algorithm (Algorithm 13) for a 2-bit LUT evaluation for multiple hidden layers, according to various example embodiments of the present invention;

FIG. 28 shows an example algorithm (Algorithm 15) for performing neural network operations homomorphically using the private network of the hybrid privacy-preserving neural network model, according to various example embodiments of the present invention;

FIG. 29 depicts a table (Table 1) showing a comparison of the first, second and third example LUT algorithms according to various example embodiments of the present invention, along with conventional FHE-DiNN and PEGASUS schemes;

FIG. 30 depicts a schematic drawing of a structure of a BP (back propagation) network with 30 nodes, according to various example embodiments of the present invention;

FIG. 31 shows a table (Table 2) presenting evaluation results in the first and second BP networks (1 hidden layer and 30/100 nodes);

FIG. 32 depicts a schematic diagram illustrating an example structure of a recognition network, according to various example embodiments of the present invention;

FIG. 33 shows a table (Table 3) presenting evaluation results obtained in a face recognition task, according to various example embodiments of the present invention;

FIG. 34 depicts a plot of test results on the noise growing in LUT+KS+Rounding operations, according to various example embodiments of the present invention;

FIG. 35 shows a table (Table 4) comparing the improved FHE scheme, the present FHE scheme and conventional FHE schemes;

FIG. 36 shows an example algorithm (Algorithm 16) for NTT multiplication, according to various example embodiments of the present invention;

FIG. 37 shows an example algorithm (Algorithm 17) for extended RLWE ciphertext multiplication (⋄), according to various example embodiments of the present invention;

FIG. 38 shows an example algorithm (Algorithm 18) for RLWE and RGSW multiplication (⊙), according to various example embodiments of the present invention;

FIG. 39 shows an example algorithm (Algorithm 19) for CRT based LUT for large modulus, according to various example embodiments of the present invention;

FIG. 40 shows an example algorithm (Algorithm 20) for (⋄) operator in RNS form, according to various example embodiments of the present invention;

FIG. 41 shows a table (Table 5) presenting performance results of the present LUT algorithm and the improved LUT algorithm, according to various example embodiments of the present invention;

FIG. 42 depicts a schematic diagram showing an example structure of 1 to 1 face recognition network, according to various example embodiments of the present invention;

FIG. 43 depicts a schematic diagram showing an example structure of 1 to N face recognition network, according to various example embodiments of the present invention;

FIG. 44 shows a table (Table 6) presenting evaluation results of the face recognition task, according to various example embodiments of the present invention; and

FIG. 45 shows a table (Table 7) presenting evaluation results of the improved system on MNIST dataset, according to various example embodiments of the present invention.

### DETAILED DESCRIPTION

Various embodiments of the present invention provide a method and a system for building a privacy-preserving neural network model. Various embodiments of the present invention also provide a method and a system for performing privacy-preserving prediction using a privacy-preserving neural network model, such as the privacy-preserving neural network model built.

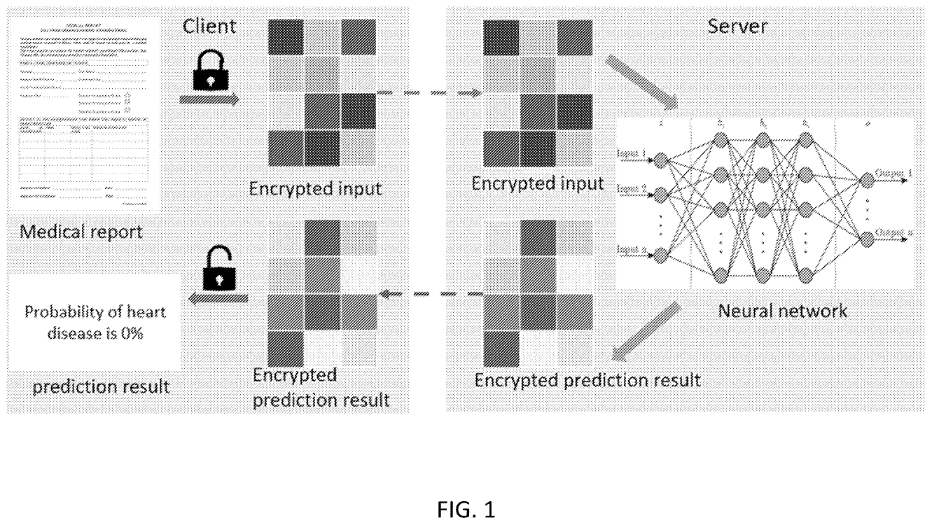

As explained in the background, existing works around privacy-preserving neural network do not perform well. For example, some works may be fast, but only support very simple activation functions (e.g., square function and sign function), which is rarely used in real or practical neural networks. On the other hand, other works may support many kinds of activation functions but are not optimized for neural networks, so they are slow and inaccurate. In addition, existing works only consider the basic privacy-preserving neural network model such as illustrated in FIG. 1, whose practical application is very limited due to poor performances. Accordingly, various embodiments of the present invention provide a method and a system for building a privacy-preserving neural network model, and a method and a system for performing privacy-preserving prediction, that seek to overcome, or at least ameliorate, one or more deficiencies in conventional privacy-preserving neural network models and conventional methods and systems for performing privacy-preserving prediction, and more particularly, to improve efficiency (e.g., improving speed) and/or effectiveness (e.g., protecting privacy, enhancing practical applications and/or enhancing prediction accuracy).

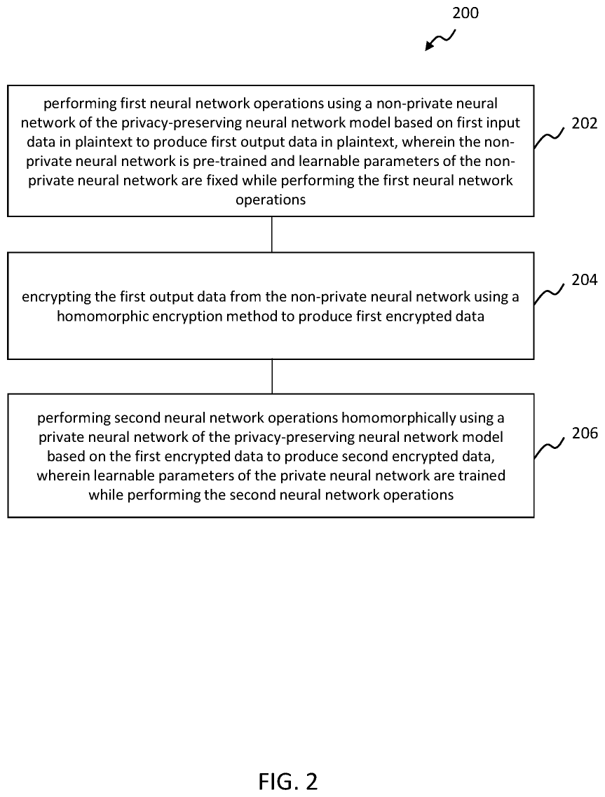

FIG. 2 depicts a schematic flow diagram of a method 200 of building a privacy-preserving neural network model according to various embodiments of the present invention. The method 200 comprises: performing (at 202) first neural network operations using a non-private neural network of the privacy-preserving neural network model based on first input data in plaintext to produce first output data in plaintext, wherein the non-private neural network is pre-trained and learnable parameters of the non-private neural network are fixed while performing the first neural network operations; encrypting (at 204) the first output data from the non-private neural network using a homomorphic encryption method (or scheme) to produce first encrypted data; and performing (at 206) second neural network operations homomorphically using a private neural network of the privacy-preserving neural network model based on the first encrypted data to produce second encrypted data, wherein learnable parameters of the private neural network are trained while performing the second neural network operations.

Accordingly, the method 200 of building a privacy-preserving neural network model according to various embodiments of the present invention advantageously enables privacy-preserving prediction applications to be implemented using the privacy-preserving neural network model in a more efficient and effective manner. In particular, the privacy-preserving neural network model is advantageously configured to have a non-private neural network (e.g., an open neural network whereby parameters thereof are not confidential (e.g., open to the public)) (which may thus also be referred to as an open neural network) and a private neural network (e.g., protected by the model owner whereby parameters thereof are kept confidential (e.g., not open to the public)). In this regard, the non-private neural network may be pre-trained (e.g., obtained from a pre-trained neural network such as an open-source pre-trained neural network) and learnable parameters (e.g., weight parameters and bias parameters (if any)) of the non-private neural network are fixed (i.e., they are not modified while the privacy-preserving neural network model is being trained). On the other hand, learnable parameters (e.g., weight parameters and bias parameters (if any)) of the private neural network are trained while performing neural network operations thereon. With such a configuration, the privacy-preserving neural network model is able to be built (e.g., trained) for a privacy-preserving prediction application of interest based on, for example, the model owner's dataset (e.g., a private dataset) catered for the privacy-preserving prediction application (thereby, enhancing prediction accuracy), while having a non-private neural network that can be provided to the public thereby allowing such a non-private neural network to be run at a client's (or user's) end to process input data (e.g., client's confidential data) in plaintext. This advantageously enables the client's end to perform neural network operations on the input data in plaintext using the non-private neural network and then encrypting the output data (e.g., feature vector(s)) of the non-private neural network prior to transmitting the encrypted data to a server for processing the encrypted data homomorphically using the private neural network to obtain a prediction result with respect to the input data. Accordingly, such a privacy-preserving neural network model advantageously enables certain neural network operations (e.g., corresponding to the above-mentioned first neural network operations) to be performed at (or offloaded to) the client's (or user's) end whereby they can be performed significantly faster in plaintext (compared to in ciphertext) without compromising privacy of the client's input data since they are performed at the client's end and are encrypted homomorphically prior to transmitting to the server for processing. The privacy of the model owner's dataset and parameters of the private neural network can also be protected.

Accordingly, the method 200 of building a privacy-preserving neural network model according to various embodiments of the present invention advantageously enables privacy-preserving prediction applications to be implemented using the privacy-preserving neural network model in a more efficient and effective manner. These advantages or technical effects, and/or other advantages or technical effects, will become more apparent to a person skilled in the art as the method and system for building a privacy-preserving neural network model, as well as the method and system for performing privacy-preserving prediction using a privacy-preserving neural network model, are described in more detail according to various embodiments and example embodiments of the present invention.

In various embodiments, the non-private neural network comprises one or more first convolution layers obtained from a pre-trained neural network.

In various embodiments, according to a first network structure, the non-private neural network further comprises one or more first fully connected layers obtained from the pre-trained neural network.

In various embodiments, according to the first network structure, the private neural network comprises one or more second fully connected layers.

In various embodiments, according to a second network structure, the private neural network comprises one or more second convolution layers and one or more first fully connected layers obtained from the pre-trained neural network, and one or more second fully connected layers.

In various embodiments, according to the second network structure, the one or more second convolution layers of the private neural network obtained from the pre-trained neural network are one or more lower convolution layers of the pre-trained neural network with respect to the one or more first convolution layers obtained from the pre-trained neural network.

In various embodiments, the one or more second fully connected layers form a shallow fully connected network. In various embodiments, the shallow fully connected network consists of one or two fully connected layers.

In various embodiments, the pre-trained neural network is an open-source pre-trained neural network.

In various embodiments, the above-mentioned first input data is labeled data from a training dataset for training the privacy-preserving neural network model, or more particularly, for training the private neural network of the privacy-preserving neural network model. In this regard, it will be appreciated by a person skilled in the art that the training dataset may comprise multiple labeled data, and thus, the above-mentioned performing (at 202) the first neural network operations, the above-mentioned encrypting (at 204) the first output data and the above-mentioned performing (at 206) second neural network operations homomorphically may be performed with respect to each respective first input data received (being respective labeled data from the training dataset), for training the privacy-preserving neural network model.

In various embodiments, the training dataset is a private dataset (e.g., kept confidential by the owner (e.g., not open to the public) and is different from a dataset on which the pre-trained neural network was trained.

In various embodiments, the above-mentioned performing (at 206) the second neural network operations comprises computing (or evaluating) a plurality of non-linear functions. In this regard, for each of the plurality of non-linear functions, the non-linear function is computed (or evaluated) homomorphically using a look-up table (LUT) algorithm. In various embodiments, the LUT algorithm is configured to produce a polynomial having encoded therein a plurality of values of the non-linear function and to produce an output ciphertext corresponding to one of the plurality of values based on the polynomial and an input ciphertext to the LUT algorithm. Accordingly, in various embodiments, the LUT algorithm is configured to encode all possible outputs/values (or “Table” of values) of the non-linear function into a polynomial so that a ciphertext (i.e., the above-mentioned input ciphertext) can be used to locate the position of the desired output without decryption. Accordingly, in various embodiments, a customized homomorphic encryption scheme is advantageously provided that is designed or optimized for neural networks, especially in relation to the computation (or evaluation) of non-linear functions (e.g., activation functions in neural networks), which has been found to improve efficiency (e.g., improving speed) and/or effectiveness (e.g., enhancing practical applications).

In various embodiments, the plurality of values of the non-linear function are encoded into coefficients of the polynomial. Accordingly, in various embodiments, the coefficients of the polynomial store all possible values of the non-linear function, respectively.

In various embodiments, the plurality of non-linear functions are a plurality of activation functions (e.g., ReLu or Sigmoid).

In various embodiments, each fully connected layer of the private neural network comprises a plurality of nodes. In this regard, for each fully connected layer of the private neural network, each of the plurality of nodes of the fully connected layer is configured to compute a respective non-linear function of the plurality of non-linear functions homomorphically using the LUT algorithm.

In various embodiments, the above-mentioned performing (at 206) the second neural network operations further comprises computing a plurality of inner product functions homomorphically. In this regard, for each fully connected layer of the private neural network, each of the plurality of nodes of the fully connected layer is configured to compute a respective inner product function of the plurality of inner product functions homomorphically based on an input ciphertext to the node and a weight matrix associated with the node to produce an output ciphertext. In this regard, the input ciphertext to the LUT algorithm for the node to compute the respective non-linear function homomorphically using the LUT algorithm corresponds to the output ciphertext of the respective inner product function. Accordingly, each node (which may also be referred to as a neuron which is an atomic unit of the neural network) of the fully connected layer may be configured to perform at least two neural network operations, namely, compute the respective inner product function homomorphically based on the input ciphertext to the node and the weight matrix associated with the node to produce the output ciphertext and then compute the respective non-linear function homomorphically using the above-mentioned LUT algorithm to produce an output ciphertext based on the input ciphertext thereto which is the output ciphertext from the inner product function.

In various embodiments, the method 200 further comprises, for each of the plurality of nodes of the fully connected layer, controlling a size of the output ciphertext produced by the respective inner product function to have a predetermined number of bits. For example, the size of the output ciphertext produced may be controlled (e.g., adjusted or reduced) so as not to exceed the predetermined number of bits. For example, after the output ciphertext has been produced by the inner product function, only a predetermined number of most significant bits may be stored or utilized by the node to compute the non-linear function homomorphically using the above-mentioned LUT algorithm.

In various embodiments, the LUT algorithm is configured to, for each of a plurality of polynomial multiplication operations therein, perform polynomial multiplication of polynomials in residue numeral system (RNS) form.

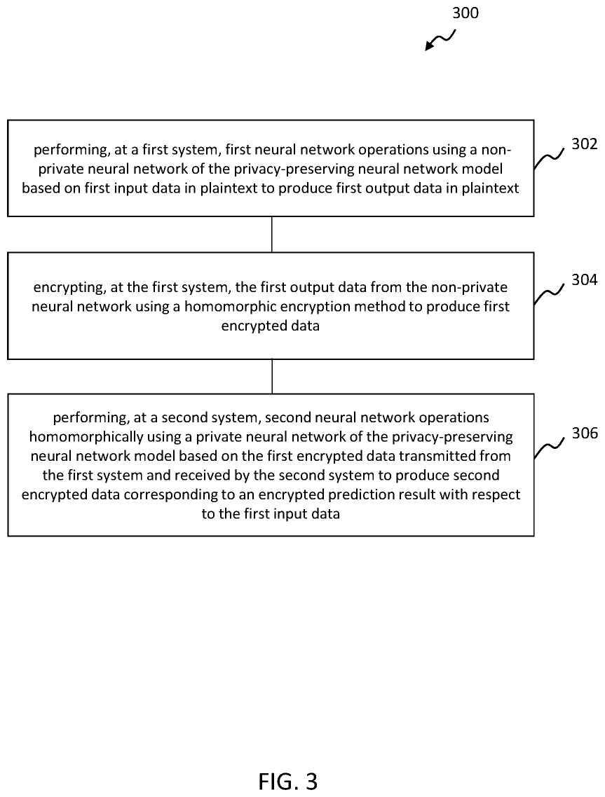

FIG. 3 depicts a schematic flow diagram of a method 300 of performing privacy-preserving prediction using a privacy-preserving neural network model, according to various embodiments of the present invention, such as using the privacy-preserving neural network model built according to the method 200 as described herein according to various embodiments of the present invention. The method 300 comprises: performing (at 302), at a first system, first neural network operations using a non-private neural network of the privacy-preserving neural network model based on first input data in plaintext to produce first output data in plaintext; encrypting (at 304), at the first system, the first output data from the non-private neural network using a homomorphic encryption method (or scheme) to produce first encrypted data; and performing (at 306), at a second system, second neural network operations homomorphically using a private neural network of the privacy-preserving neural network model based on the first encrypted data transmitted from the first system and received by the second system to produce second encrypted data corresponding to an encrypted prediction result with respect to the first input data.

Accordingly, similar to the method 200 of building a privacy-preserving neural network model as described hereinbefore according to various embodiments, the method 300 of performing privacy-preserving prediction using a privacy-preserving neural network model according to various embodiments of the present invention advantageously enables privacy-preserving prediction applications to be implemented using the privacy-preserving neural network model in a more efficient and effective manner. In particular, the privacy-preserving neural network model is advantageously configured to have a non-private neural network (e.g., an open neural network whereby parameters thereof are not confidential (e.g., open to the public)) and a private neural network (e.g., protected by the model owner whereby parameters thereof are kept confidential (e.g., not open to the public)). With such a configuration, the non-private neural network can be provided to the public thereby allowing such a non-private neural network to be run at a client's (or user's) end to process input data (e.g., client's confidential data) in plaintext. This advantageously enables the client's end to perform neural network operations on the input data in plaintext using the non-private neural network and then encrypting the output data (e.g., feature vector(s)) of the non-private neural network prior to transmitting the encrypted data to a server for processing the encrypted data homomorphically using the private neural network to obtain a prediction result with respect to the input data. Accordingly, such a privacy-preserving neural network model advantageously enables certain neural network operations (e.g., corresponding to the above-mentioned first neural network operations) to be performed at (or offloaded to) the client's (or user's) end whereby they can be performed significantly faster in plaintext (compared to in ciphertext) without compromising privacy of the client's input data since they are performed at the client's end and are encrypted homomorphically prior to transmitting to the server for processing. The privacy of the model owner's dataset and parameters of the private neural network can also be protected.

In various embodiments, in relation to the method 300, the non-private neural network comprises one or more first convolution layers obtained from a pre-trained neural network.

In various embodiments, in relation to the method 300 and according to a first network structure, the non-private neural network further comprises one or more first fully connected layers obtained from the pre-trained neural network.

In various embodiments, in relation to the method 300 and according to the first network structure, the private neural network comprises one or more second fully connected layers.

In various embodiments, in relation to the method 300 and according to a second network structure, the private neural network comprises one or more second convolution layers and one or more first fully connected layers obtained from the pre-trained neural network, and one or more second fully connected layers.

In various embodiments, in relation to the method 300, the one or more second fully connected layers form a shallow fully connected network. In various embodiments, the shallow fully connected network consists of one or two fully connected layers.

In various embodiments, in relation to the method 300, the pre-trained neural network is an open-source pre-trained neural network.

In various embodiments, in relation to the method 300, the private neural network has been trained based on labeled data (or multiple labeled data) from a training dataset. In various embodiments, the training dataset may be a private dataset (e.g., kept confidential by the owner (e.g., not open to the public).

In various embodiments, in relation to the method 300, the above-mentioned performing the second neural network operations comprises computing (or evaluating) a plurality of non-linear functions. In this regard, for each of the plurality of non-linear functions, the non-linear function is computed (or evaluated) homomorphically using a LUT algorithm. In various embodiments, the LUT algorithm is configured to produce a polynomial having encoded therein a plurality of values of the non-linear function and to produce an output ciphertext corresponding to one of the plurality of values based on the polynomial and an input ciphertext to the LUT algorithm. Accordingly, in various embodiments, the LUT algorithm is configured to encode all possible outputs/values (or “Table” of values) of the non-linear function into a polynomial so that a ciphertext (i.e., the above-mentioned input ciphertext) can be used to locate the position of the desired output without decryption. Accordingly, in various embodiments, a customized homomorphic encryption scheme is advantageously provided that is designed or optimized for neural networks, especially in relation to the computation (or evaluation) of non-linear functions (e.g., activation functions in neural networks), which has been found to improve efficiency (e.g., improving speed) and/or effectiveness (e.g., enhancing practical applications and/or enhancing prediction accuracy).

In various embodiments, in relation to the method 300, the plurality of values of the non-linear function are encoded into coefficients of the polynomial. Accordingly, in various embodiments, the coefficients of the polynomial store all possible values of the non-linear function, respectively.

In various embodiments, in relation to the method 300, the plurality of non-linear functions are a plurality of activation functions (e.g., ReLu or Sigmoid).

In various embodiments, in relation to the method 300, each fully connected layer of the private neural network comprises a plurality of nodes. In this regard, for each of one or more fully connected layers of the private neural network (e.g., all fully connected layers of the private neural network except the output layer), each of the plurality of nodes of the fully connected layer is configured to compute a respective non-linear function of the plurality of non-linear functions homomorphically using the LUT algorithm.

In various embodiments, in relation to the method 300, the above-mentioned performing the second neural network operations further comprises computing a plurality of inner product functions homomorphically. In this regard, for the above-mentioned each of one or more fully connected layers of the private neural network, each of the plurality of nodes of the fully connected layer is configured to compute a respective inner product function of the plurality of inner product functions homomorphically based on an input ciphertext to the node and a weight matrix associated with the node to produce an output ciphertext. In this regard, the input ciphertext to the LUT algorithm for the node to compute the respective non-linear function homomorphically using the LUT algorithm with respect to the node corresponds to the output ciphertext of the respective inner product function. Accordingly, each node of the fully connected layer may be configured to perform at least two neural network operations, namely, compute the respective inner product function homomorphically based on the input ciphertext to the node and the weight matrix associated with the node to produce the output ciphertext and then compute the respective non-linear function homomorphically using the above-mentioned LUT algorithm to produce an output ciphertext based on the input ciphertext thereto which is the output ciphertext from the inner product function.

In various embodiments, the method 300 further comprises, for each of the plurality of nodes of the fully connected layer, controlling a size of the output ciphertext produced by the respective inner product function to have a predetermined number of bits. For example, the size of the output ciphertext produced may be controlled (e.g., adjusted or reduced) so as not to exceed the predetermined number of bits. For example, after the output ciphertext has been produced by the inner product function, only a predetermined number of most significant bits may be stored or utilized by the node to compute the non-linear function homomorphically using the above-mentioned LUT algorithm.

In various embodiments, in relation to the method 300, the LUT algorithm is configured to, for each of a plurality of polynomial multiplication operations therein, perform polynomial multiplication of polynomials in RNS form.

In various embodiments, in relation to the method 300, the first system has stored therein the non-private neural network of the privacy-preserving neural network model and the second system has stored therein the private neural network of the privacy-preserving neural network model.

In various embodiments, the first system and the second system may communicate with each other based on various communication protocols or networks known in the art, including wired or wireless communication networks, such as but not limited to, Ethernet, cellular or mobile communication network (e.g., 3G, 4G, 5G or higher generation mobile communication network), Wi-Fi, Bluetooth, wired or wireless sensor network, satellite communication network, wired or wireless personal or local area network and so on.

In various embodiments, the privacy-preserving neural network model is built according to the method 200 as described herein according to various embodiments of the present invention.

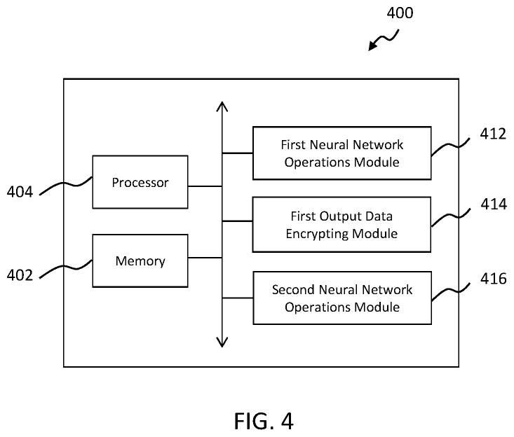

FIG. 4 depicts a schematic block diagram of a system 400 for building a privacy-preserving neural network model according to various embodiments of the present invention, corresponding to the above-mentioned method 200 of building a privacy-preserving neural network model as described hereinbefore according with reference to FIG. 2 according to various embodiments of the present invention. The system 400 comprises: at least one memory 402; and at least one processor 404 communicatively coupled to the at least one memory 402 and configured to perform the method 200 of building a privacy-preserving neural network model as described hereinbefore according to various embodiments of the present invention. Accordingly, the at least one processor 404 is configured to: perform the above-mentioned first neural network operations (at 202); perform the above-mentioned encrypting (at 204) the first output data; and perform the above-mentioned second neural network operations homomorphically (at 206).

It will be appreciated by a person skilled in the art that the at least one processor 404 may be configured to perform various functions or operations through set(s) of instructions (e.g., software modules) executable by the at least one processor 404 to perform various functions or operations. Accordingly, as shown in FIG. 4, the system 400 may comprise: a first neural network operations module (or a first neural network operations circuit) 412 configured to perform the above-mentioned first neural network operations (at 202); a first output data encrypting module (or a first output data encrypting circuit) 414 configured to perform the above-mentioned encrypting (at 204) the first output data; and a second neural network operations module (or a second neural network operations circuit) 416 configured to perform the above-mentioned second neural network operations homomorphically (at 206).

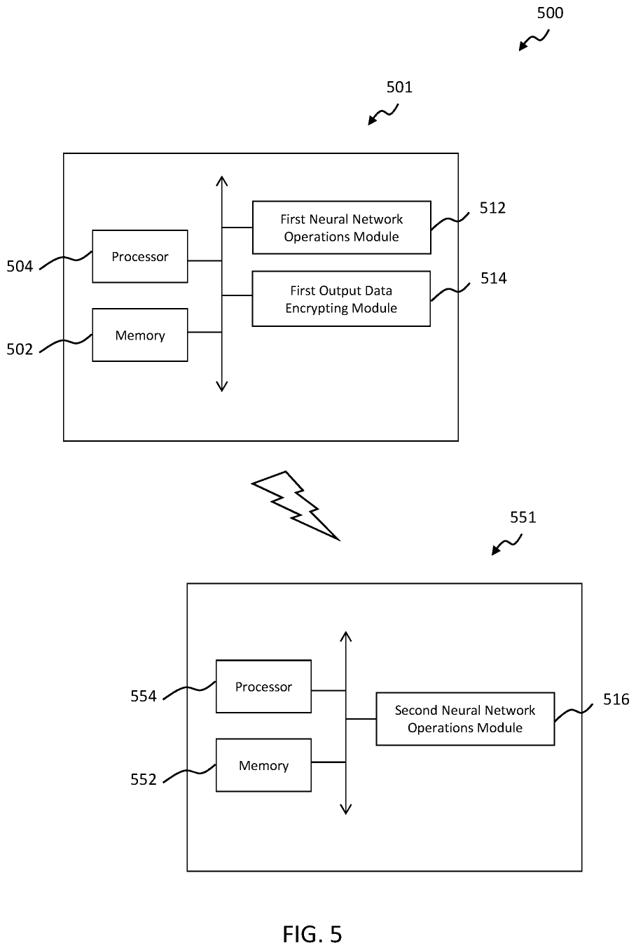

FIG. 5 depicts a schematic block diagram of a system 500 for performing privacy-preserving prediction using a privacy-preserving neural network model according to various embodiments of the present invention, corresponding to the above-mentioned method 300 of performing privacy-preserving prediction as described hereinbefore according with reference to FIG. 3 according to various embodiments of the present invention. The system 500 comprises a first system 501 (which may also be embodied as a device or an apparatus) and a second system 551 (which may also be embodied as a device or an apparatus). The first system 501 comprises at least one memory 502; and at least one processor 504 communicatively coupled to the at least one memory 502 and configured to perform the above-mentioned first neural network operations (at 302) and the above-mentioned encrypting (at 304) the first output data of the method 300 of performing privacy-preserving prediction according to various embodiments of the present invention. The second system 551 comprising: at least one memory 552; and at least one processor 554 communicatively coupled to the at least one memory 552 and configured to perform the above-mentioned second neural network operations homomorphically (at 306) of the method 300 of performing privacy-preserving prediction according to various embodiments of the present invention.

It will be appreciated by a person skilled in the art that the at least one processor 504 may be configured to perform various functions or operations through set(s) of instructions (e.g., software modules) executable by the at least one processor 504 to perform various functions or operations. Accordingly, as shown in FIG. 5, the system 501 may comprise: a first neural network operations module (or a first neural network operations circuit) 512 configured to perform the above-mentioned first neural network operations (at 302) and a first output data encrypting module (or a first output data encrypting circuit) 514 configured to perform the above-mentioned encrypting (at 304) the first output data.

Similarly, it will be appreciated by a person skilled in the art that the at least one processor 554 may be configured to perform various functions or operations through set(s) of instructions (e.g., software modules) executable by the at least one processor 554 to perform various functions or operations. Accordingly, as shown in FIG. 5, the system 551 may comprise a second neural network operations module (or a second neural network operations circuit) 516 configured to perform the above-mentioned second neural network operations homomorphically (at 306).

It will be appreciated by a person skilled in the art that various modules of a system are not necessarily separate modules, and two or more modules may be realized by or implemented as one functional module (e.g., a circuit or a software program) as desired or as appropriate without deviating from the scope of the present invention. For example, two or more modules of the system 400 for building a privacy-preserving neural network model (e.g., the first neural network operations module 412, the first output data encrypting module 414 and the second neural network operations module 416) may be realized (e.g., compiled together) as one executable software program (e.g., software application or simply referred to as an “app”), which for example may be stored in the at least one memory 402 and executable by the at least one processor 404 to perform various functions/operations as described herein according to various embodiments of the present invention.

In various embodiments, the system 400 for building a privacy-preserving neural network model corresponds to the method 200 of building a privacy-preserving neural network model as described hereinbefore with reference to FIG. 2 according to various embodiments, therefore, various functions or operations configured to be performed by the least one processor 404 may correspond to various steps or operations of the method 200 of building a privacy-preserving neural network model as described hereinbefore according to various embodiments, and thus need not be repeated with respect to the system 400 for building a privacy-preserving neural network model for clarity and conciseness. In other words, various embodiments described herein in context of the methods are analogously valid for the corresponding systems, and vice versa.

For example, in various embodiments, the at least one memory 402 may have stored therein the first neural network operations module 412, the first output data encrypting module 414 and/or the second neural network operations module 416, which correspond to one or more steps (or operation(s) or function(s)) of the method 200 of building a privacy-preserving neural network model as described herein according to various embodiments, which are executable by the at least one processor 404 to perform the corresponding function(s) or operation(s) as described herein.

Similarly, in various embodiments, the system 500 for performing privacy-preserving prediction corresponds to the method 300 of performing privacy-preserving prediction as described hereinbefore with reference to FIG. 3 according to various embodiments, therefore, various functions or operations configured to be performed by the least one processor 504 and the least one processor 554 may correspond to various steps or operations of the method 300 of performing privacy-preserving prediction as described hereinbefore according to various embodiments, and thus need not be repeated with respect to the system 500 for performing privacy-preserving prediction for clarity and conciseness.

For example, in various embodiments, the at least one memory 502 of the first system 501 may have stored therein the first neural network operations module 512 and/or the first output data encrypting module 514, which correspond to one or more steps (or operation(s) or function(s)) of the method 300 of performing privacy-preserving prediction as described herein according to various embodiments, which are executable by the at least one processor 504 to perform the corresponding function(s) or operation(s) as described herein. Similarly, in various embodiments, the at least one memory 552 of the second system 551 may have stored therein the second neural network operations module 516, which corresponds to one or more steps (or operation(s) or function(s)) of the method 300 of performing privacy-preserving prediction as described herein according to various embodiments, which are executable by the at least one processor 554 to perform the corresponding function(s) or operation(s) as described herein.

A computing system, a controller, a microcontroller or any other system providing a processing capability may be provided according to various embodiments in the present disclosure. Such a system may be taken to include one or more processors and one or more computer-readable storage mediums. For example, the system 400 for building a privacy-preserving neural network model described hereinbefore may include at least one processor (or controller) 404 and at least one computer-readable storage medium (or memory) 402 which are for example used in various processing carried out therein as described herein. A memory or computer-readable storage medium used in various embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g., a microprocessor (e.g., a Complex Instruction Set Computer (CISC) processor or a Reduced Instruction Set Computer (RISC) processor). A “circuit” may also be a processor executing software, e.g., any kind of computer program, e.g., a computer program using a virtual machine code, e.g., Java. Any other kind of implementation of the respective functions may also be understood as a “circuit” in accordance with various embodiments. Similarly, a “module” may be a portion of a system according to various embodiments and may encompass a “circuit” as described above, or may be understood to be any kind of a logic-implementing entity.

Some portions of the present disclosure are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, description or discussions utilizing terms such as “performing”, “encrypting”, “computing”, “building” or the like, refer to the actions and processes of a computer system, or similar electronic device, that manipulates and transforms data represented as physical quantities within the computer system into other data similarly represented as physical quantities within the computer system or other information storage, transmission or display devices.

The present specification also discloses various systems (e.g., each may also be embodied as a device or an apparatus), such as the system 400 for building a privacy-preserving neural network model, the first system 501 and the second system 551, for performing various operations/functions of various methods described herein. Such systems may be specially constructed for the required purposes, or may comprise a general purpose computer or other device selectively activated or reconfigured by a computer program stored in the computer. The algorithms presented herein are not inherently related to any particular computer or other apparatus. Various general-purpose machines may be used with computer programs in accordance with the teachings herein. Alternatively, the construction of more specialized apparatus to perform various method steps may be appropriate.

In addition, the present specification also at least implicitly discloses a computer program or software/functional module, in that it would be apparent to the person skilled in the art that individual steps of various methods described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the scope of the invention. It will be appreciated by a person skilled in the art that various modules described herein (e.g., the first neural network operations module 412, the first output data encrypting module 414, the second neural network operations module 416, the first neural network operations module 512, the first output data encrypting module 514, and/or the second neural network operations module 516) may be software module(s) realized by computer program(s) or set(s) of instructions executable by a computer processor to perform the required functions, or may be hardware module(s) being functional hardware unit(s) designed to perform the required functions. It will also be appreciated that a combination of hardware and software modules may be implemented.

Furthermore, two or more of the steps of a computer program/module or method described herein may be performed in parallel rather than sequentially. Such a computer program may be stored on any computer readable medium. The computer readable medium may include storage devices such as magnetic or optical disks, memory chips, or other storage devices suitable for interfacing with a computer. The computer program when loaded and executed on such the computer effectively results in a system or an apparatus that implements various steps of methods described herein.

In various embodiments, there is provided a computer program product, embodied in one or more computer-readable storage mediums (non-transitory computer-readable storage medium(s)), comprising instructions (e.g., the first neural network operations module 412, the first output data encrypting module 414 and/or the second neural network operations module 416) executable by one or more computer processors to perform the method 200 of building a privacy-preserving neural network model, as described herein with reference to FIG. 2 according to various embodiments. Accordingly, various computer programs or modules described herein may be stored in a computer program product receivable by a system therein, such as the system 400 for building a privacy-preserving neural network model as shown in FIG. 4, for execution by at least one processor 404 of the system 400 to perform various functions.

Similarly, in various embodiments, there is provided a computer program product, embodied in one or more computer-readable storage mediums (non-transitory computer-readable storage medium(s)), comprising instructions (e.g., the first neural network operations module 512, the first output data encrypting module 514, and/or the second neural network operations module 516) executable by one or more computer processors to perform the method 300 of performing privacy-preserving prediction, as described herein with reference to FIG. 3 according to various embodiments. Accordingly, various computer programs or modules described herein may be stored in a computer program product receivable by a system therein, such as the first system 501 and the second system 551 for performing privacy-preserving prediction as shown in FIG. 5, for execution by at least one processor 504 of the first system 501 and for execution by at least one processor 554 of the second system 551 to perform various functions.

Software or functional modules described herein may also be implemented as hardware modules. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the software or functional module(s) described herein can also be implemented as a combination of hardware and software modules.

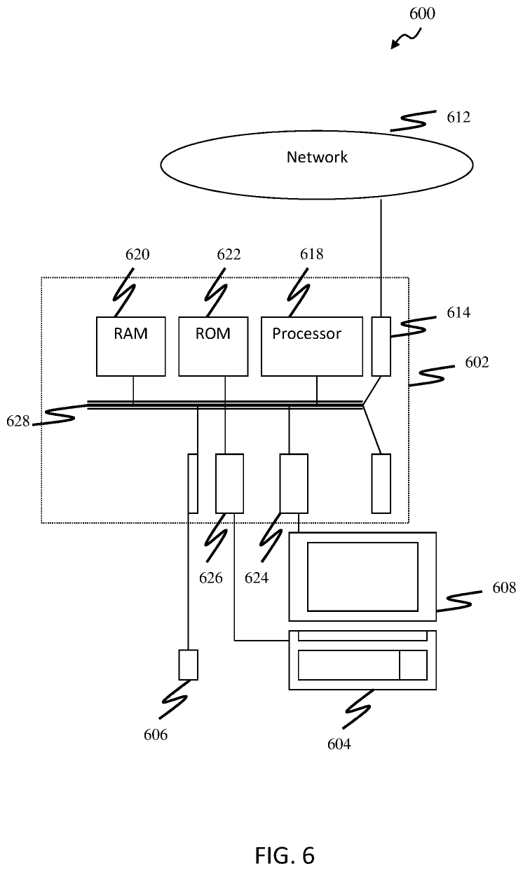

In various embodiments, the system 400, the first system 501 and/or the second system 551 may each be realized by any computer system (e.g., desktop or portable computer system (e.g., mobile device)) including at least one processor and at least one memory, such as an example computer system 600 as schematically shown in FIG. 6 as an example only and without limitation. Various methods/steps or functional modules may be implemented as software, such as a computer program being executed within the computer system 600, and instructing the computer system 600 (in particular, one or more processors therein) to conduct various functions or operations as described herein according to various embodiments. The computer system 600 may comprise a system unit 602, input devices such as a keyboard and/or a touchscreen 604 and a mouse 606, and a plurality of output devices such as a display 608. The system unit 602 may be connected to a computer network 612 via a suitable transceiver device 614, to enable access to e.g., the Internet or other network systems such as Local Area Network (LAN) or Wide Area Network (WAN). The system unit 602 may include a processor 618 for executing various instructions, a Random Access Memory (RAM) 620 and a Read Only Memory (ROM) 322. The system unit 602 may further include a number of Input/Output (I/O) interfaces, for example I/O interface 624 to the display device 608 and I/O interface 626 to the keyboard 604. The components of the system unit 602 typically communicate via an interconnected bus 628 and in a manner known to a person skilled in the art.

It will be appreciated by a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Any reference to an element or a feature herein using a designation such as “first”, “second” and so forth does not limit the quantity or order of such elements or features, unless stated or the context requires otherwise. For example, such designations may be used herein as a convenient way of distinguishing between two or more elements or instances of an element. Thus, a reference to first and second elements does not necessarily mean that only two elements can be employed, or that the first element must precede the second element. In addition, a phrase referring to “at least one of” a list of items refers to any single item therein or any combination of two or more items therein.

In order that the present invention may be readily understood and put into practical effect, various example embodiments of the present invention will be described hereinafter by way of examples only and not limitations. It will be appreciated by a person skilled in the art that the present invention may, however, be embodied in various different forms or configurations and should not be construed as limited to the example embodiments set forth hereinafter. Rather, these example embodiments are provided so that this disclosure will be thorough and complete, and will fully convey the scope of the present invention to those skilled in the art.

To facilitate practical applications, various example embodiments provide improvements on both the privacy-preserving neural network model structure and the homomorphic encryption scheme. In this regard, there is provided a hybrid privacy-preserving neural network model (which may be referred to herein as the present hybrid model) and a customized fully homomorphic encryption (FHE) method or scheme (which may be referred to herein as the present FHE method or scheme) for neural network. Under the present hybrid model, for example, face recognition can be performed in few seconds using the present FHE scheme according to various example embodiments, which can take more than a few days under the basic privacy-preserving neural network model shown in FIG. 1.

Various example embodiments note that since homomorphic computations (or calculations) on encrypted data are much slower than the computations on plaintext, the basic privacy-preserving neural network model (i.e., using ciphertext in the whole neural network model) is very slow and can only be applied in a simple network. In contrast, to speed up the prediction, various example embodiments advantageously divide the neural network model into two parts: an open neural network (which may simply be referred to herein as an open network, e.g., corresponding to the non-private neural network as described hereinbefore according to various embodiments) and a private neural network (which may simply be referred to herein as a private network). Accordingly, such a privacy-preserving neural network model according to various example embodiments of the present invention may be referred to as a hybrid privacy-preserving neural network model.

As an illustrative example according to the present hybrid model, a user may first run the open network in plaintext locally and then the user may encrypt the result (or output) of the open network and send the encrypted output in ciphertext to a server configured to run the private network in ciphertext. After receiving the encrypted output from the user, the server may run the private network in ciphertext to produce an encrypted prediction output and such an encrypted prediction output may then be transmitted to the user. In this regard, computations in plaintext are much faster than computations in ciphertext, therefore since the present hybrid model according to various example embodiments of the present invention enables the above-mentioned neural network computations to be performed locally at the user's end in plaintext, the present hybrid model is significantly faster than the basic privacy-preserving neural network model.

In various example embodiments, the open network may comprise a number of general feature extracting layers and can be public to all users. The private network may comprise a number of lower feature extracting layers which are more related with, or relevant to, the privacy-preserving prediction application (or task) and the dataset associated therewith. For example, parameters of the private network may be sensitive or private, and the model owner may not be willing to open them to public. In this regard, the present hybrid model enables the model owner to provide the private network at a secured server which allows a user to make a query to perform the privacy-preserving prediction task by transmitting the above-mentioned encrypted output to the server. Accordingly, the hybrid privacy-preserving neural network model according to various example embodiments advantageously improve efficiency while protecting the privacy of both the user and the model owner.

In the present FHE scheme, various example embodiments note and utilise an observation that neural network is generally good at tolerating noise. In this regard, at various steps of the present FHE scheme according to various example embodiments, a number of most significant bits of the data are kept (or a number of least significant bits are removed), which helps to reduce the size of encryption parameters and further improves the efficiency of the system. In various example embodiments, this may be performed with respect to an input data prior to encrypting the input data homomorphically (e.g., discarding a number of least significant bits of the input data before encrypting it), and with respect to an output ciphertext produced by an inner product function at a node prior to the node computing the non-linear function homomorphically using the LUT algorithm based on the output ciphertext (e.g., discarding a number of least significant bits of the above-mentioned output ciphertext prior to being input to the LUT algorithm. For example, a number of least significant bits may be discarded by multiplying by an integer and discarding the floating part (i.e., rounding to an integer). As an example, the most significant 4 bits may be kept by multiplying by 16 and then rounding the result to an integer. In various example embodiments, by controlling how many bits are kept, a good balance between accuracy and performance can be achieved. For example, the number of bits kept may depend on requirements of the prediction task of interest. If the prediction task requires very high precision, then more bits may be kept. On the other hand, if a faster performance is desired, then less bits may be kept. For example, the number of bits to be kept may be decided or determined through experiments that best meets the requirements.

Accordingly, the hybrid privacy-preserving neural network model according to various example embodiments is advantageous over the basic privacy-preserving neural network model, which can be used to solve a variety of complex and practical prediction problems. Furthermore, the present FHE scheme is advantageously optimized for neural networks. As a result, it is fast for performing neural network operations on ciphertext and can support many types of activation functions. As will be discussed later below, in experiments conducted, the present FHE scheme according to various example embodiments achieves better results in both prediction accuracy and time than other existing works.

The hybrid privacy-preserving neural network model and the present FHE scheme will now be described in further detail according to various example embodiments of the present invention.

### Hybrid Privacy-Preserving Neural Network Model

### Overview

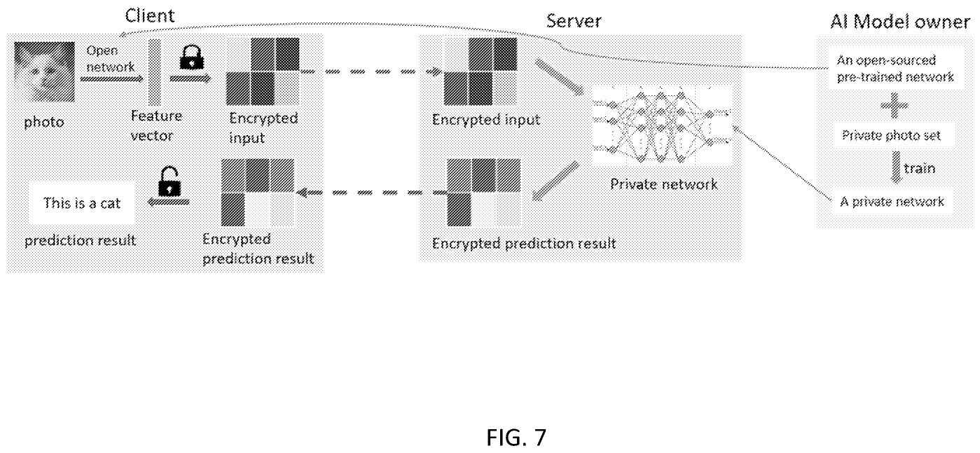

Various example embodiments note that, for example, due to the limitation of hardware, the basic privacy-preserving neural network model cannot be used to solve a variety of practical and complex prediction problems, such as but not limited to, face recognition. To facilitate practical applications, as described above, various example embodiments advantageously divide the neural network model into two parts: an open network and a private network, thereby resulting in a hybrid privacy-preserving neural network model (or the present hybrid model). In this regard, FIG. 7 depicts a schematic drawing of the hybrid privacy-preserving neural network model according to various example embodiments of the present invention.

For example, the hybrid privacy-preserving neural network model advantageously addresses two privacy problems. Firstly, from the perspective of a model owner (or an artificial intelligence (AI) model owner), the model owner may wish to train the neural network model using a private dataset but may not be willing to share parameters (e.g., weight parameters and bias parameters (if any)) of the trained neural network model with others. Secondly, from the perspective of a user, the user of the neural network model may not be willing to disclose both the user's input data (e.g., including confidential information such as a medical report) and the prediction results to the model owner or a server running the trained neural network model. To address the former problem, the hybrid privacy-preserving neural network model according to various example embodiments enables the model owner to publish the open network to the public and provide the private network at a secured server which allows a user to make queries to perform privacy-preserving prediction tasks. To address the latter problem, the user may encrypt their data by homomorphic encryption prior to transmitting the encrypted data to the server for performing computations on the encrypted data in relation to a privacy-preserving prediction task.

In various example embodiments, edge computing may be used to drive the present hybrid model. As shown in FIG. 7, according to the present hybrid model, the user (which may also be referred to as a client, e.g., corresponding to the first system 501 as described hereinbefore with reference to FIG. 5 according to various embodiments) may first run the open network of the present hybrid model in plaintext locally. The user may then encrypt the output (e.g., a feature vector or a set of feature vectors) from the open network and send the encrypted output in ciphertext to the server (e.g., corresponding to the second system 551 as described hereinbefore with reference to FIG. 5 according to various embodiments). The server may then run the private network of the present hybrid model in ciphertext and output an encrypted prediction result.

For example, in practical applications, such as face recognition and image classification, there are many open-source pre-trained neural network projects. Since both the parameters and models of these projects are public, according to various example embodiments, the open network of the present hybrid model may be formed or obtained based on an open-source pre-trained neural network. However, an open-source pre-trained neural network project cannot solve the problems described hereinbefore completely. In this regard, various example embodiments apply transfer learning for training a network (e.g., a small network) subsequent to the open network by using a private dataset. In this regard, since parameters of the small network may be sensitive (or confidential), such a small network may be set as the private network of the present hybrid model. As mentioned hereinbefore, computations in plaintext is significantly faster than in ciphertext (e.g., more than 10,000 times faster). Accordingly, regardless of how deep and complex the open network is, in various example embodiments, the present hybrid model can achieve good performance as long as the private network is shallow and simple.

### Training Method and Neural Network Structure

Various example embodiments employ transfer learning as a tool for training the private network in the present hybrid model. Transfer learning focuses on storing knowledge gained while solving problem and applying it to a different but related problem. Various example embodiments note that, from practical standpoints, transferring information from previously learned tasks for the learning of new tasks may significantly improve the sample efficiency. How to use transfer learning to train the private network in the present hybrid model will now be described according to various example embodiments of the present invention. Assuming that a neural network model is desired to be built to solve task B based on a dataset D₂, an open-source pre-trained network on a related task A (trained by dataset D₁) may first be searched. If such a pre-trained network is found, then transfer learning may be applied to build the present hybrid model according to various example embodiments of the present invention. According to various example embodiments, two example hybrid model building (or training) methods are provided to build a hybrid model on task B based on the pre-trained network on task A.

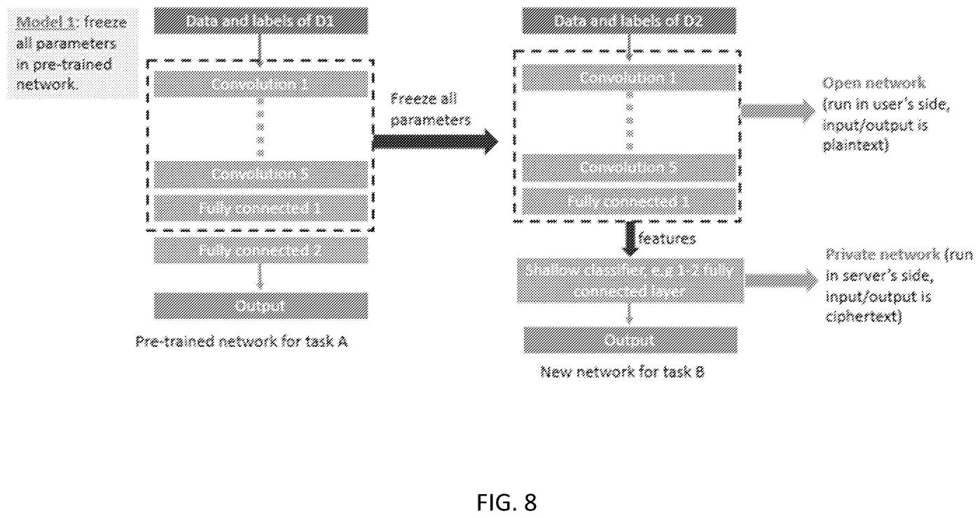

FIG. 8 depicts a schematic diagram illustrating a first example hybrid model building method, along with an example network structure of the corresponding first example hybrid model built (e.g., corresponding to the first network structure as described hereinbefore according to various embodiments), according to various example embodiments of the present invention. The first example building method includes freezing (or fixing) all parameters (e.g., weight parameters and bias parameters (if any)) of the pre-trained network. In this regard, the pre-trained network may be used as a feature extractor. The first example building method may further include adding a fully connected network (e.g., one or more fully connected layers), such as a simple and shallow fully connected network (e.g., consisting of one or two fully connected layers), and training the fully connected network on features (e.g., feature vectors) from the open network produced based on labeled data from the training dataset (e.g., dataset D₂). Accordingly, as shown in FIG. 8, the first example hybrid model may comprise an open network comprising one or more convolution layers (e.g., five convolution layers) and one or more fully connected layers (e.g., one fully connected layer) obtained from the pre-trained network and a private network comprising one or more fully connected layers (e.g., one or two fully connected layers). It will be appreciated by a person skilled in the art that the first example hybrid model is not limited to the specific number of layers as shown in FIG. 8 (which is only an illustrative example) and the number of convolution layers and fully connected layers may be set or configured as desired or as appropriate. For example, although various example embodiments may configure the private network to form a shallow fully connected network (i.e., having one or two fully connected layers) for faster performance, the private network is not limited to being a shallow fully connected network and may comprise more than two fully connected layers as desired or as appropriate based on other factor(s) (e.g., higher accuracy).

According to various example embodiments, since the pre-trained network is open-source and parameters thereof are not modified (e.g., not modified by dataset D₂), the pre-trained network is set as the open network of the first example hybrid model. On the other hand, the fully connected network (e.g., the shallow fully connected network) is trained based on a training dataset associated with the prediction task of interest (e.g., based on dataset D₂), the fully connected network is set as the private network of the first example hybrid model. In various example embodiments, as shown in FIG. 8, the last fully connected layer of the pre-trained network is not transferred/utilized in the first example hybrid model since such a last fully connected layer was configured to perform classification with respect to the original prediction task of interest (i.e., the prediction task of the pre-trained network).

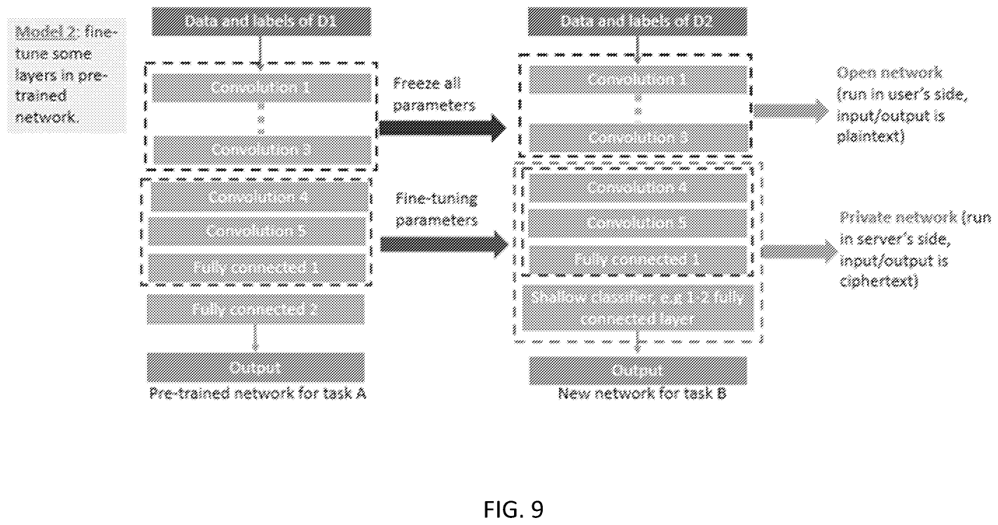

FIG. 9 depicts a schematic diagram illustrating a second example hybrid model building method, along with an example network structure of the corresponding second example hybrid model built (e.g., corresponding to the second network structure as described hereinbefore according to various embodiments), according to various example embodiments of the present invention. The second example building method includes fine-tuning (or further training) a number of layers of the pre-trained network. In various example embodiments, the second example building method may be employed when task A and task B are not very similar, or the dataset associated with the prediction task of interest (e.g., dataset D₂) is large. In particular, the second example building method includes freezing (only) parameters (e.g., weight parameters and bias parameters (if any)) of a number of top layers of the pre-trained network and adding a fully connected network (e.g., one or more fully connected layers), such as a simple and shallow fully connected network (e.g., consisting of one or two fully connected layers). Then, a number of lower layers of the pre-trained network together with the fully connected network are trained on features (e.g., feature vectors) from the open network produced based on labeled data from the training dataset associated with the prediction task of interest (e.g., dataset D₂). Accordingly, as shown in FIG. 9, the second example hybrid model may comprise an open network comprising one or more convolution layers (e.g., three convolution layers) obtained from the pre-trained network and a private network comprising one or more convolution layers (e.g., two convolution layers) and one or more fully connected layers (e.g., one fully connected layer) obtained from the pre-trained network and one or more additional fully connected layers (e.g., one or more fully connected layers). Similar to the first example hybrid model, it will be appreciated by a person skilled in the art that the second example hybrid model is also not limited to the specific number of layers as shown in FIG. 9 (which is only an illustrative example) and the number of convolution layers and fully connected layers may be set or configured as desired or as appropriate.

In various example embodiments, the frozen layers of the pre-trained network may be set as the open network of the second example hybrid model since they are not modified (e.g., not modified by dataset D₂). On the other hand, since parameters of the lower layers of the pre-trained network are further trained (or re-trained) by the training dataset associated with the prediction task of interest, both the lower layers of the pre-trained network and the fully connected network (e.g., the shallow fully connected network) are set as the private network of the second example hybrid model. In various example embodiments, similar to the first example hybrid model, as shown in in FIG. 9, the last fully connected layer of the pre-trained network is not transferred/utilized in the second example hybrid model since such a last fully connected layer was configured to perform classification with respect to the original prediction task of interest (i.e., the prediction task of the pre-trained network.

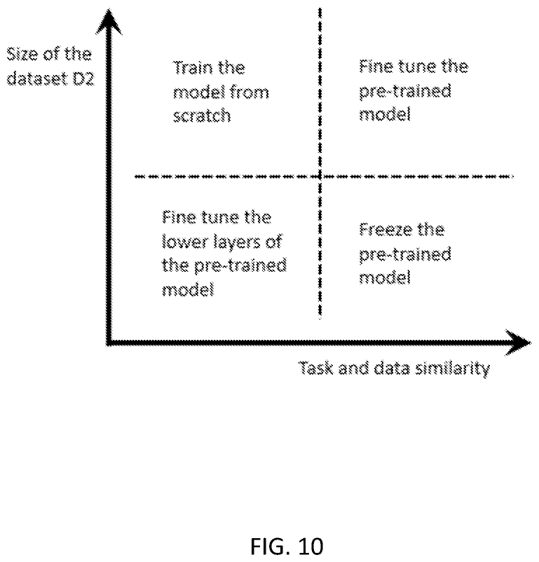

In various example embodiments, selecting a model building (or training) method or approach may be based on a number of factors, including (1) task and data similarity and (2) size of the dataset associated with the prediction task of interest (e.g., size of dataset D₂). As an example illustration, FIG. 10 depicts a graph illustrating a general approach for selecting a model building method based on the above-mentioned two factors according to various example embodiments of the present invention. In various example embodiments, the selection of a model building method may depend on the prediction task of interest (e.g., facial recognition, hand-written number recognition or object classification) and in various instances may be decided by experiments in plaintext. For example, to achieve better results, different model building methods may be tested and the best or optimal model building method according to experimental results may then be selected.

As can be seen in FIG. 10, in the worst case whereby a suitable open-source pre-trained network cannot be found with respect to the prediction task of interest, an entire privacy-preserving neural network model may be trained from scratch and a first part or section of the trained model may be set as the open network and a second part or section (e.g., the remaining part or section) of the trained model may be set as the private network to form the hybrid privacy-preserving neural network model according to various example embodiments of the present invention. For example, the network structure of such a hybrid model formed may be the same or similar to the first example hybrid model as described hereinbefore with reference to FIG. 8 according to various example embodiments or the second example hybrid model as described hereinbefore with reference to FIG. 9 according to various example embodiments. Accordingly, in various example embodiments, it is not necessary that the open network is formed from a pre-trained neural network.

In various example embodiments, the present hybrid model may comprise a feature extraction part and a classification part, and the feature extraction part may be set as the open network while the classification part may be set as the private network.

### FHE Scheme for the Private Neural Network

After selecting or determining an appropriate training method and network structure, the FHE method (or scheme) for the neural network may then be selected or determined according to various example embodiments of the present invention. In this regard, since the open network of the present hybrid model is running in plaintext, FHE schemes are considered for the private network of the present hybrid model according to various example embodiments of the present invention.

In various example embodiments, two FHE schemes may be selected, namely, the CKKS homomorphic encryption scheme (such as described in Jung Hee Cheon, et al., “Homomorphic encryption for arithmetic of approximate numbers”, In International Conference on the Theory and Application of Cryptology and Information Security, pages 409-437. Springer, 2017, herein referred to as the Cheon reference) and a customized FHE scheme (which may be referred to herein as the present FHE scheme) according to various example embodiments of the present invention.

Various example embodiments note that the CKKS scheme may be good at linear computations but cannot calculate non-linear activation functions efficiently in general. In practice, the only non-linear activation function the CKKS scheme can perform is the square function. Since both the data size and noise grow rapidly in the square function, the CKKS scheme may thus be more suitable for shallow networks.

The present FHE scheme comprises an optimized homomorphic look-up table (LUT) algorithm configured to compute a large variety of types of non-linear functions (e.g., activation functions such as, but not limited to, ReLu and Sigmoid activation functions) efficiently. In this regard, since various example embodiments use programmable bootstrapping to refresh the ciphertexts when computing non-linear functions, the present FHE scheme is more suitable for deep networks or shallow networks where the square function cannot be used.

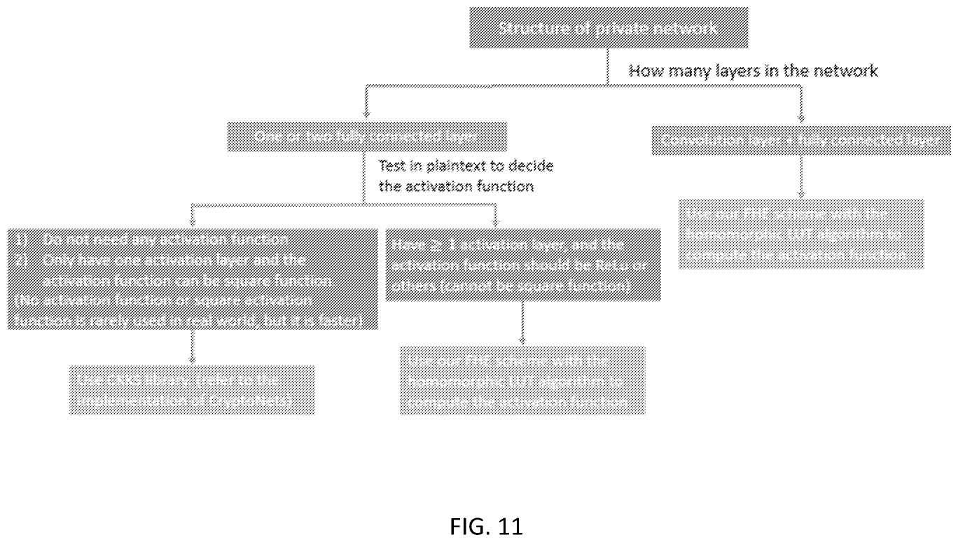

As an example illustration, FIG. 11 depicts a graph illustrating a general approach for selecting or determining a FHE scheme for the private neural network based on the structure of the private neural network according to various example embodiments of the present invention. For example, if the structure of the private network comprises one or more convolution layers and one or more fully connected layers (e.g., the private network of the second example hybrid model shown in FIG. 9), the present FHE scheme may be used, including the homomorphic LUT algorithm for computing the activation function. If the structure of the private network consists of one or two fully connected layers, a test may first be performed in plaintext to decide or determine the activation function. If it is determined that the private network does not need any activation function or only has one activation layer and the activation function can be square function, then the CKKS homomorphic encryption scheme may be used. On the other hand, if it is determined that the private network has one or more activation layer and there is no activation function that is square function (e.g., can be ReLu or other type of activation function), the present FHE scheme may be used, including the homomorphic LUT algorithm for computing the activation function.

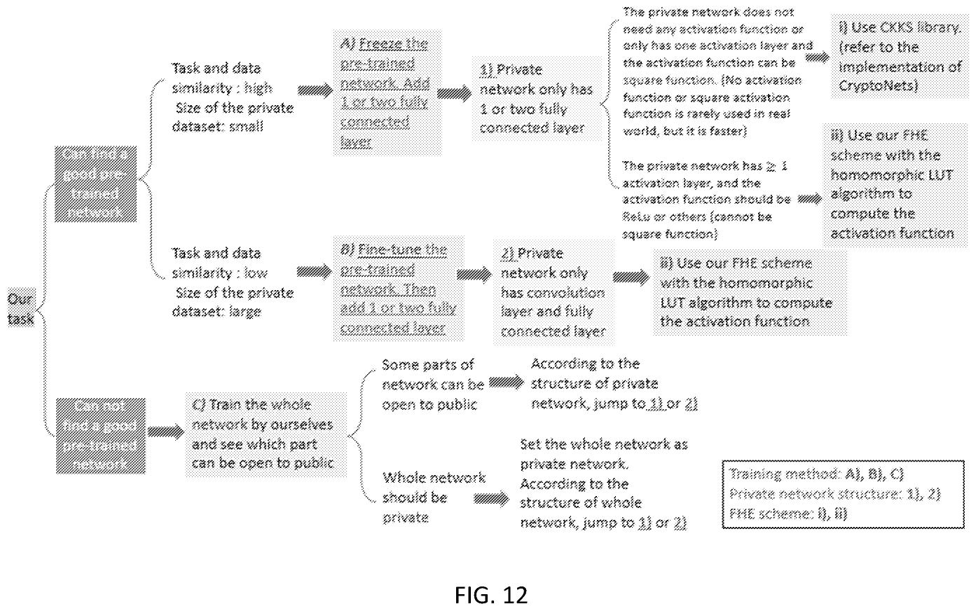

As an overview for better understanding, FIG. 12 depicts a schematic flow diagram showing a summary for (1) determining the model building (or training) method, (2) the private network structure and (3) the FHE scheme for the private network, according to various example embodiments of the present invention.

### Customized FHE Scheme for Privacy-Preserving Neural Network Model

### Overview

Various example embodiments seek to provide or design a customized homomorphic encryption scheme for neural networks that:
1. can be applied to any depth neural network;
2. supports a large variety of types of non-linear functions (in particular, activation functions); and
3. is fast and accurate.

According to various example embodiments, the customized homomorphic encryption scheme (or the system thereof) is built on both a LWE-based secret key encryption scheme and a RLWE-based secret key encryption scheme. In various example embodiments, all parts of the customized homomorphic encryption scheme (or the system thereof) run on integer, which advantageously allows the application of faster algorithms in implementation (e.g., faster polynomial multiplication algorithm: number theoretic transform (NTT)).

The LWE-based secret key encryption scheme is used to encrypt the input test. Assuming that the length of an input vector is lᵢₙ, lᵢₙ LWE ciphertexts may then be generated based on the input vector. In each ciphertext, according to the good noise-tolerance of neural network, for example, the CKKS method disclosed in the above-mentioned Cheon reference may be applied to add a noise following significant bits containing a main message. As a result, various example embodiments may choose relatively small ciphertext modulus and dimension.

In various example embodiments, the customized homomorphic encryption scheme comprises the following algorithms.

(1) Homomorphic evaluation for inner-product on LWE ciphertext. Since the LWE secret key encryption scheme is additive homomorphic, the inner-product between a ciphertext vector and a plaintext vector can be computed by homomorphic scale multiplication and addition.

(2) Homomorphic evaluation for non-linear functions. Although FHE can be used to compute any type of functions, various example embodiments note that conventional FHE schemes are too slow and far from practical, especially in relation to non-linear functions. To address this problem, various example embodiments provide and use a homomorphic look-up table (LUT) algorithm to compute non-linear functions. In particular, according to the LUT algorithm, all possible outputs of the non-linear function g(·) are encoded into a polynomial ƒ(X) (denoted by a LUT function) so that a ciphertext can be used to locate the position of the desired output without decryption. In various example embodiments, the RLWE-based secret key encryption scheme is used to encrypt the evaluation key for the LUT algorithm.

In order to achieve better efficiency, various example embodiments seeks to configure the degree of polynomials in the LUT algorithm to be small. In this regard, various example embodiments advantageously utilize the noise tolerance of neural network. Before entering the LUT process, various example embodiments may control or squeeze the output range of the inner-product function. For example, only a number (e.g., a few) of most significant bits may be stored and a number of inaccurate least significant bits may be removed. For example, the number of most significant bits to be kept (or the number of least significant bits to be removed) may be determined or set as desired or as appropriate based on various factors, such as the range of data desired, and the accuracy and efficiency/performance requirements (e.g., a balance between accuracy and performance). In various example embodiments, the coefficients of the LUT function ƒ(X) (i.e., the polynomial) store all possible values of the LUT algorithm's output, so the number of coefficients (i.e., the degree of ƒ(X)) is decided by the input data range of the LUT algorithm (i.e., the output data range of the inner-product). Accordingly, various example embodiments can advantageously achieve a small degree of LUT function by squeezing the inner-product into a corresponding small data range. For example, the data range can be squeezed to 1/8 of the original data by discarding the three least significant bits.

(3) Homomorphic rounding and key switching. Various example embodiments note that the output of the LUT algorithm is a LWE ciphertext whose secret key and ciphertext modulus may be in different scale with the parameters used in encrypting the input test. In order to ensure that the network model is extendable and can be applied to deep neural network, various example embodiments employ homomorphic rounding and key switching to reduce the ciphertext size.

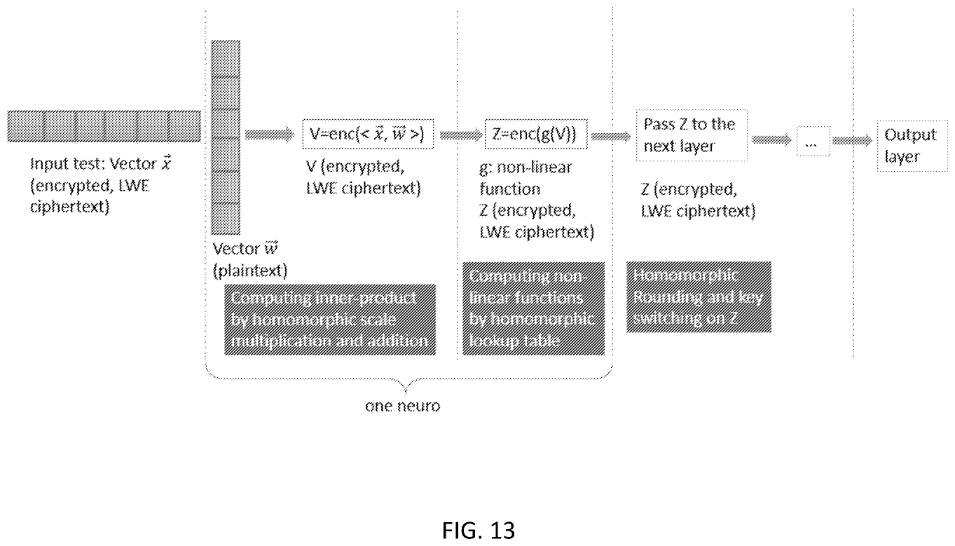

For better understanding, FIG. 13 depicts a schematic diagram of neural network operations performed at a node (which may also be referred to as a neuron) of a layer in a neural network according to various example embodiments of the present invention. As shown in FIG. 13, the neural network operations performed at the node may include computing an inner product function homomorphically based on an input ciphertext (vector \vec{x}) and weight parameters (vector \vec{w} in plaintext) by homomorphic scale multiplication and addition, computing a non-linear function (g(·)) based on the output ciphertext (V) of the inner product function by using the homomorphic LUT algorithm, and performing homomorphic rounding and key switching operation based on the output ciphertext (Z) of the non-linear function to obtain an output ciphertext of the rounding and key switching operation. Accordingly, in various example embodiments, each fully connected layer of the private network comprises a plurality of nodes. In this regard, it will be appreciated by a person skilled in the art that the neural network operations at each node of each fully connected layer of the private network are performed in the same or similar manner in both the training phase/stage and the prediction phase/stage of the private network, except that in the prediction phase, the nodes in the output layer of the private network do not need to evaluation the non-linear function. That is, in training phase, the nodes in the output layer evaluate the non-linear function while in prediction phase, the nodes in the output layer can skip such an evaluation of the non-linear function.

Accordingly, in various example embodiments, in the training phase of the private network, for each fully connected layer of the private network, each of the plurality of nodes of the fully connected layer is configured to perform neural network operations, including computing a respective inner product function homomorphically and a respective non-linear function homomorphically using the LUT algorithm, such as described with reference to FIG. 13. In various example embodiments, in the prediction phase of the private network, for each of one or more fully connected layers of the private network (e.g., all fully connected layers of the private network except the output layer), each of the plurality of nodes of the fully connected layer is configured to perform neural network operations, including computing a respective inner product function homomorphically and a respective non-linear function homomorphically using the LUT algorithm, such as described with reference to FIG. 13. In various example embodiments, the above-mentioned each node is configured to compute a respective inner product function homomorphically based on an input ciphertext to the node and a weight matrix associated with the node to produce an output ciphertext. In this regard, the input ciphertext to the LUT algorithm for the node to compute the respective non-linear function homomorphically using the LUT algorithm corresponds to the output ciphertext of the respective inner product function. Furthermore, the above-mentioned each node is configured to compute (or evaluate) the non-linear function homomorphically using a look-up table (LUT) algorithm. In this regard, the LUT algorithm is configured to encode all possible outputs/values (or “Table” of values) of the non-linear function into a polynomial so that a ciphertext (i.e., the above-mentioned input ciphertext) can be used to locate the position of the desired output without decryption.

### Notations

For a 2-power number n, we write Rⁿ= [symbol] [X]/(Xⁿ+1) and R_{q}ⁿ=Rⁿ/qRⁿ= [symbol] _{q}[X]/(Xⁿ+1), where R denotes a ring structure, Z denotes that the elements are in the integer ring, X denotes the variant of polynomial, and q denotes a prime modulus. Subscript in stands for the input layer, and subscript out stands for the output layer. A bracket [·] is used for the specific slot in a vector/matrix. In addition, wₗ[i,j], bₗ[i]∈Z denote scaled weights and bias vectors from layer l−1 to layer l and sₗ ∈ [symbol] denotes scaler of weights and bias vectors from layer l−1 to layer 1.

### Additive Homomorphic LWE Encryption

The LWE-based secret key encryption scheme and related computations/operations will now be described in further detail with reference to FIGS. 15 to 16 according to various example embodiments by way of examples only.

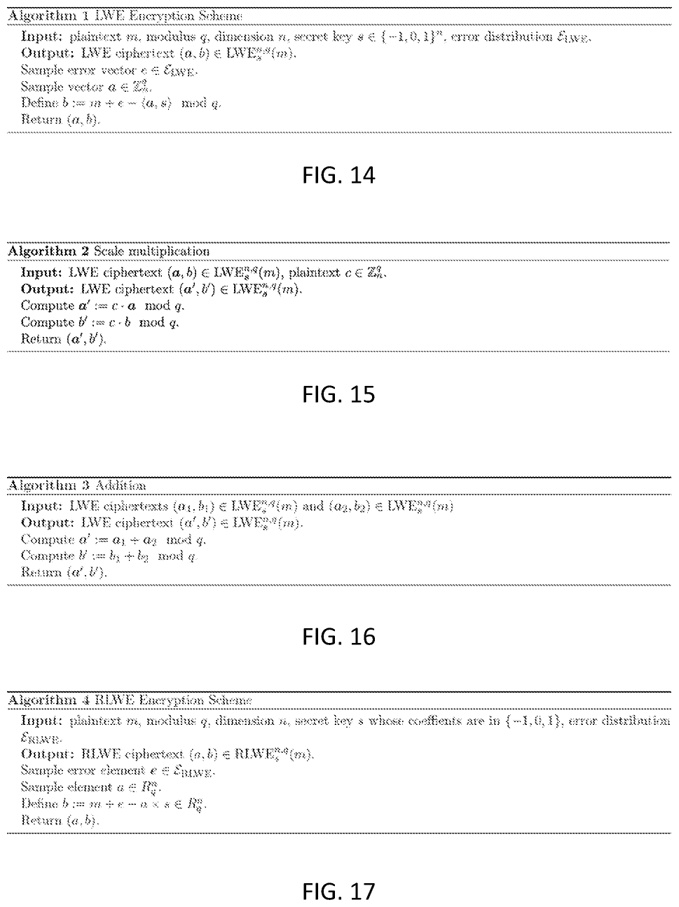

FIG. 14 shows an example algorithm (Algorithm 1) for the LWE encryption scheme according to various example embodiments of the present invention. In particular, a LWE ciphertext (a, b) is produced by the LWE encryption scheme based on an input plaintext (or message) m, modulus q, dimension n, secret key s and error distribution ε_{LWE}, whereby a denotes a vector with length n and each element is in [0, q−1], b denotes a number in [0, q−1] Therefore, each LWE ciphertext may consist of n+1 numbers and each of them is in [0, q−1].

FIG. 15 shows an example algorithm (Algorithm 2) for the scale multiplication according to various example embodiments of the present invention. In particular, a LWE ciphertext (a′, b′) is produced by the scale multiplication based on a LWE ciphertext (a, b) and a plaintext c.

FIG. 16 shows an example algorithm (Algorithm 3) for the addition according to various example embodiments of the present invention. In particular, a LWE ciphertext (a′, b′) is produced by the addition based on a first LWE ciphertext (aᵢ, bᵢ) and a second LWE ciphertext (a₂, b₂).

### RLWE Encryption and Related Operations

The RLWE-based secret key encryption scheme and related computations/operations will now be described in further detail with reference to FIGS. 17 to 21 according to various example embodiments by way of examples only.

FIG. 17 shows an example algorithm (Algorithm 4) for the RLWE encryption scheme according to various example embodiments of the present invention. In particular, a RLWE ciphertext (a, b) is produced by the RLWE encryption scheme based on an input plaintext m, modulus q, dimension n, secret key s and error distribution ε_{RLWE}, whereby a and b denote two polynomials in the polynomial ring R_{q}ⁿ.

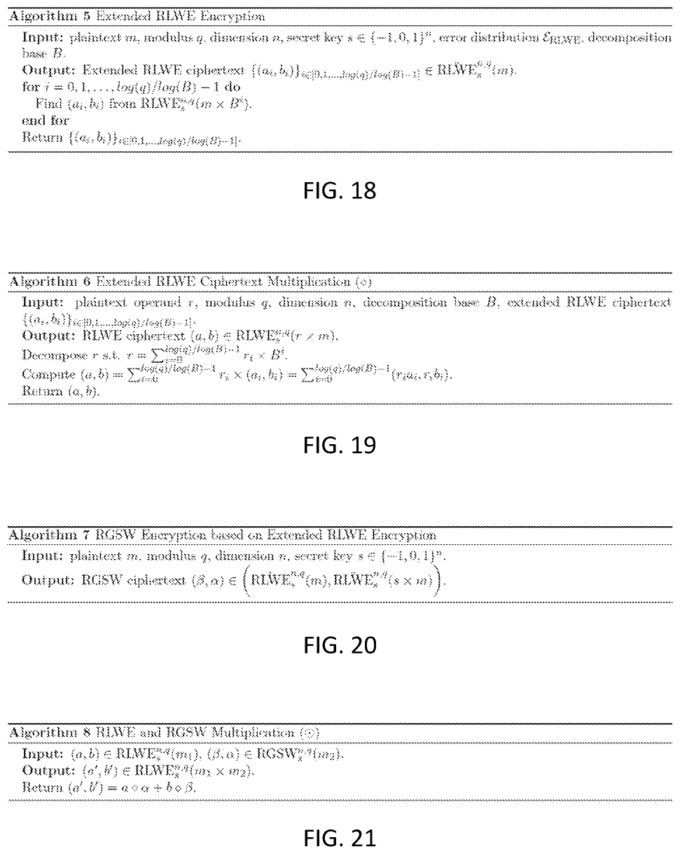

FIG. 18 shows an example algorithm (Algorithm 5) for the extended RLWE encryption according to various example embodiments of the present invention. In particular, an extended RLWE ciphertext {(aᵢ, bᵢ)} is produced by the extended RLWE encryption scheme based on an input plaintext (or message) m, modulus q, dimension n, secret key s, error distribution ε_{RLWE}, and decomposition base B, whereby the extended RLWE ciphertext is a set of RLWE ciphertexts which encrypts message m×Bⁱ under secret key s.

FIG. 19 shows an example algorithm (Algorithm 6) for the extended RLWE ciphertext multiplication (⋄) according to various example embodiments of the present invention. In particular, a RLWE ciphertext (a, b) is produced by the extended RLWE ciphertext multiplication based on plaintext operand r, modulus q, dimension n, decomposition base B and extended RLWE ciphertext {(aᵢ, bᵢ)}.

FIG. 20 shows an example algorithm (Algorithm 7) for the RGSW encryption based on extended RLWE encryption according to various example embodiments of the present invention. In particular, a RGSW ciphertext (β, α) is produced by the RGSW encryption based on a plaintext m, modulus q, dimension n and secret key s, whereby the RGSW ciphertext comprises two extended RLWE ciphertexts which encrypt m and s×m respectively.

FIG. 21 shows an example algorithm (Algorithm 8) for the RLWE and RGSW multiplication (⊙) according to various example embodiments of the present invention. In particular, a RLWE ciphertext (a′, b′) is produced by the RLWE and RGSW multiplication based on a RLWE ciphertext (a, b) and a RGSW ciphertext (β, α).

### Building Blocks of the Customized FHE Scheme

A number of key building blocks (or algorithms) of the present FHE scheme will now be described in further detail according to various example embodiments of the present invention by way of examples only.

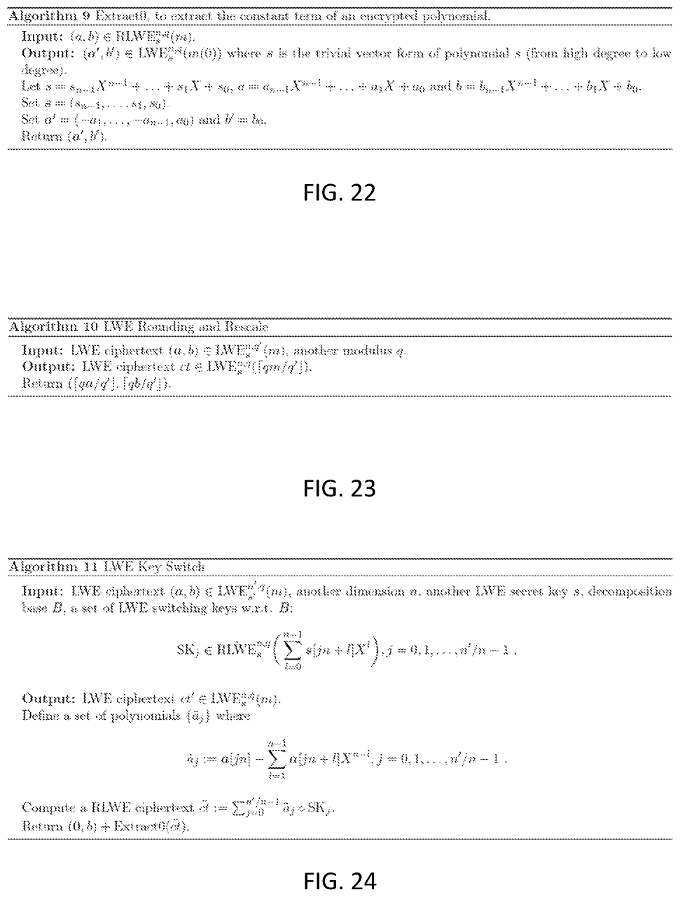

Extraction, homomorphic rounding and key switching algorithms. FIG. 22 shows an example algorithm (Algorithm 9) for an extract operation (Extract0) according to various example embodiments of the present invention. According to various example embodiments, Extract0 is configured to extract the constant term of an encrypted polynomial m from a RLWE ciphertext RLWESₛ^{n,q}(m). It is configured to output a LWE ciphertext (a′, b′) which encrypts the 0-th coefficient of m. This extraction algorithm allows the conversion of a RLWE ciphertext into LWE ciphertexts and is used in a number of the following algorithms. In this regard, the constant term of the polynomial m refers to that the coefficient of X⁰. For example, s₀ is the constant term of polynomial s. According to various example embodiments, the purpose of this algorithm is to obtain a LWE ciphertext which encrypts the result of the LUT algorithm. For example, the output of this algorithm can be verified by evaluating decryption algorithm on (a′,b′).

Rounding and key switching. FIG. 23 shows an example algorithm (Algorithm 10) for the LWE rounding and rescale operation according to various example embodiments of the present invention, and FIG. 24 shows an example algorithm (Algorithm 11) for the LWE key switch operation according to various example embodiments of the present invention. In various example embodiments, the homomorphic rounding algorithm is configured to change a LWE ciphertext (a, b) with ciphertext modulus q′ to a LWE ciphertext ct with ciphertext modulus q. In various example embodiments, the key switching algorithm is configured to change a LWE ciphertext (a, b) with secret key s′ and dimension n′ to a LWE ciphertext ct′ with new secret key s and dimension n.

Homomorphic LUT algorithm. The LUT algorithm according to various example embodiments is configured to take a LWE ciphertext ct∈LWEₛ^{n,q}(m) and a evaluation function F(·) as input and output a LWE ciphertext which encrypts ΔF(m), where A is a scale parameter. In this regard, various example embodiments provide a number of possible example LUT algorithms that may be employed depending on various factors as will be explained below.

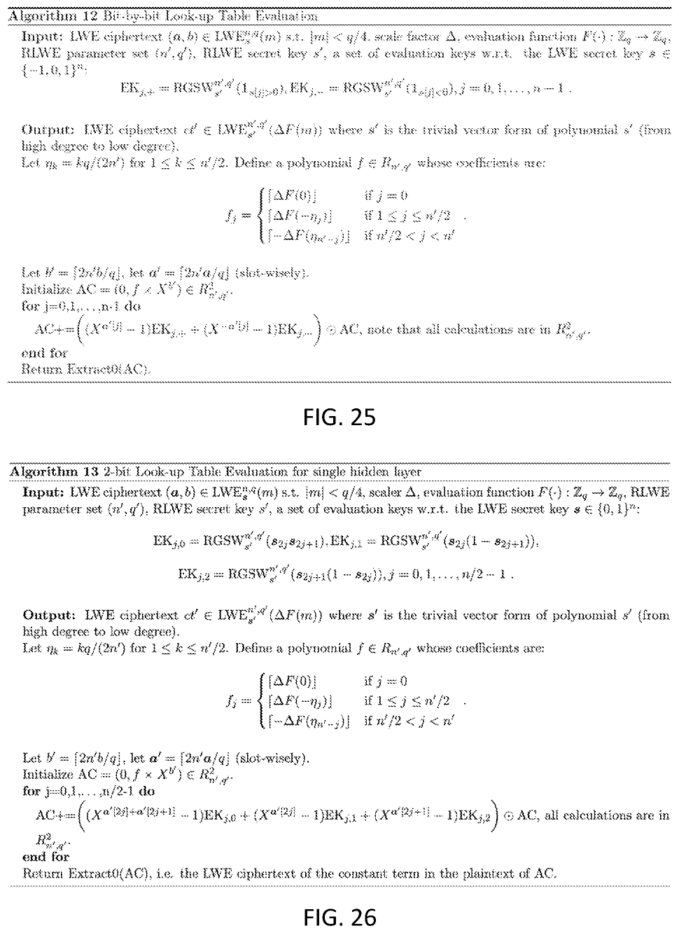

Bit-by-bit Look-up table algorithm for general cases. As a first example LUT algorithm, a bit-by-bit LUT evaluation will now be described with reference to FIG. 25 according to various example embodiments of the present invention, which can be used in any cases. In particular, FIG. 25 shows an example algorithm (Algorithm 12) for the bit-by-bit LUT evaluation according to various example embodiments of the present invention. As can be seen from FIG. 25, the example LUT algorithm is configured to produce a polynomial ƒ having encoded therein a plurality of values of the non-linear function F(·) and to produce an output ciphertext corresponding to one of the plurality of values based on the polynomial and an input ciphertext (a, b) to the example LUT algorithm. In this regard, the example LUT algorithm is configured to encode all possible outputs/values (or “Table” of values) of a non-linear function into a polynomial so that a ciphertext (i.e., the above-mentioned input ciphertext) can be used to locate the position of the desired output without decryption. In particular, the plurality of values of the non-linear function F(·) are encoded into coefficients of the polynomial ƒ. For example, for each sⱼ, EK_{j, +} is an encryption of 1 if sⱼ>0 and encryption of 0 otherwise, and EK_{j,-} is an encryption of 1 if sⱼ<0 and encryption of 0 otherwise. In the example algorithm, +=refers to the operation in C++ coding, where a+=b means a=a+b. The coefficients of polynomial ƒ are the evaluating results of ΔF(·) on all possible inputs. The aim of loop in the example algorithm is to homomorphically evaluate the LWE decryption function over a RLWE scheme, which will bring the evaluation ΔF(m) to the constant term of the resulting polynomial.

2-bit Look-up table algorithm for single hidden layer. According to various example embodiments, in the case that the neural network (i.e., the private network) only has one hidden layer, the key switch and rounding operations can be skipped after the LUT evaluation, and proceed to the output layer directly. In this case, when encrypting the input test, the LWE secret key s∈{0,1}ⁿ can be used instead of s∈{-1,0,1}ⁿ, while the security can still be proved. In this case, a second example LUT algorithm referred to as a 2-bit LUT evaluation for single hidden layer according to various example embodiments may be employed to reduce the number of external operations from n to n/2. In particular, FIG. 26 shows an example algorithm (Algorithm 13) for the 2-bit LUT evaluation for single hidden layer according to various example embodiments of the present invention.

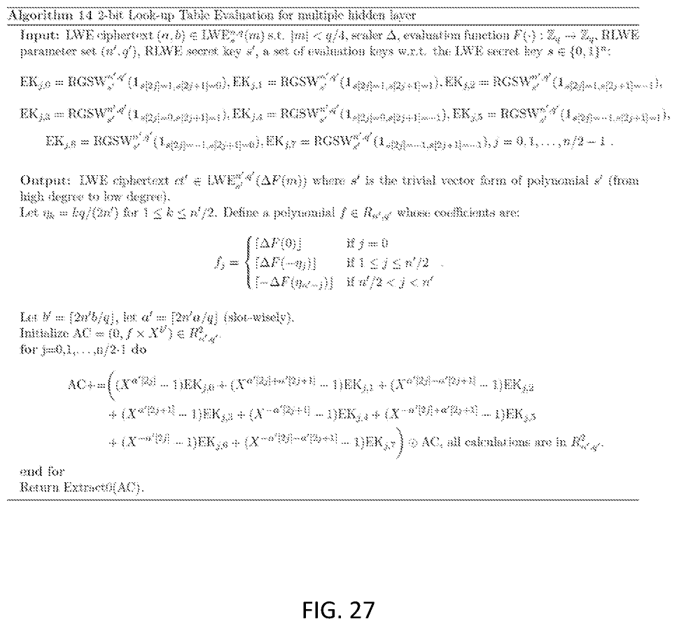

2-bit Look-up table algorithm for multiple hidden layers. In this case, the key switching algorithm is required between each hidden layer, which include computations on RLWE ciphertexts. However, the binary secret for the Ring variant of LWE is still an open problem, and thus, the LWE secret key from s∈{-1,0,1}ⁿ cannot be converted to s∈{0,1}here. To address this, as a third example LUT algorithm, various example embodiments provide a 2-bit LUT algorithm for multiple hidden layers. In particular, FIG. 27 shows an example algorithm (Algorithm 13) for the 2-bit LUT evaluation for multiple hidden layers according to various example embodiments of the present invention. Similar to the 2-bit LUT evaluation for single hidden layer shown in FIG. 26, the 2-bit LUT algorithm for multiple hidden layers lists possible results of computing sⱼsⱼ+₁ so that the number of loops is reduced by half.

### Framework for the Hybrid Privacy-Preserving Neural Network Model

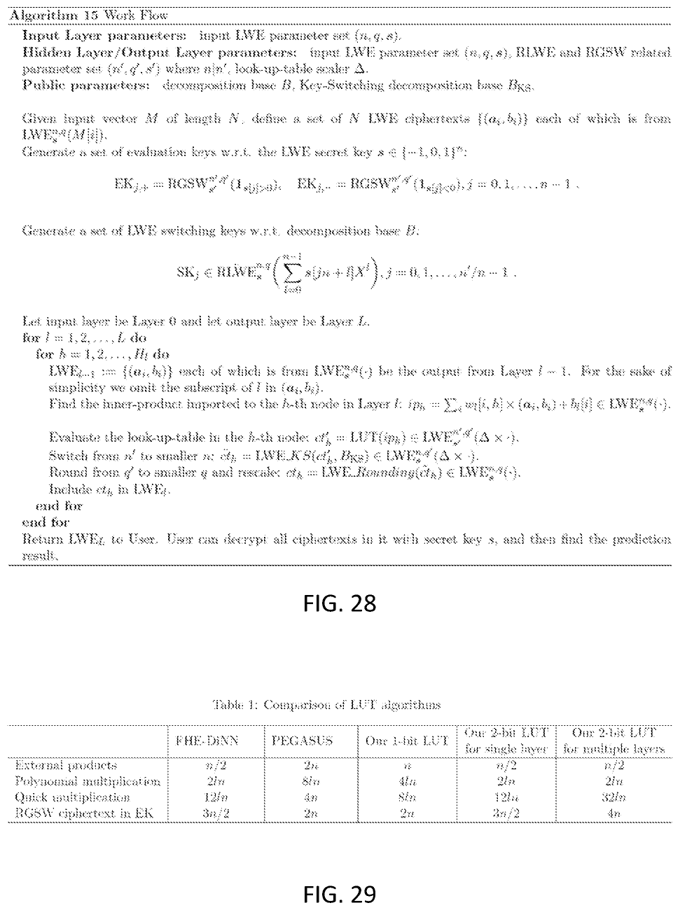

The hybrid privacy-preserving neural network model will now be described in further detail according to various example embodiments with reference to FIG. 28. In particular, FIG. 28 shows an example algorithm (Algorithm 15) for performing neural network operations homomorphically using the private network of the hybrid privacy-preserving neural network model according to various example embodiments of the present invention. As shown in FIG. 28, in relation to input layer parameters, there is provided an input LWE parameter set (n, q, s). In relation to hidden layer/output layer parameters, there are provided an input LWE parameter set (n, q, s), RLWE and RGSW related parameter set (n′, q′, s′) where n|n′, and look-up-table scaler Δ. In relation to public parameters, there are provided decomposition base B and key-switching decomposition base B_{KS}. In the example algorithm, an input data is encrypted by LWE encryption scheme under secret key s and modulus q. As shown, for each node (for each layer (l=1, 2, . . . , L), and each node (h=1, 2, . . . , Hi) of the layer l), the node is configured to homomorphically evaluate the inner-product and use the LUT algorithm to evaluate the non-linear activation function, such as described hereinbefore according to various example embodiments. The output of the LUT algorithm is a LWE ciphertext ctₕ′ under secret key s′ and modulus q′. In this regard, before such an output LWE ciphertext is passed to the next layer, the key switch algorithm and the rounding algorithm are performed to switch the key and modulus back to s and q. Therefore, the example algorithm can advantageously be applied to neural network with any depth.

### Noise Analysis

According to various example embodiments, the growing of noise throughout the present FHE scheme (or the system thereof) is analyzed.

Notations. Let σ_{LWE}² be the variance of noise used in the LWE encryption. σ_{RGSW}²; σ_{KS}² in the same way.

As widely used assumptions, in each polynomial it is assumed that all the coefficients behave like independent zero-mean random variables of the same variance (weaker than i.i.d.), and central limit heuristic. Further, note that it suffices to find the change of error variance within one node of each layer. Fix Layer l, assume that LWEₗ₋₁:={(aᵢ, bᵢ)} has an error whose variance is a² in each LWE ciphertext.

Inner product. ipₕ=Σᵢ wₗ[i, h]×(aᵢ, bᵢ)+b₁[i]∈LWEₛ^{n,q}(·) and thus the noise becomes eᵢₚ with σᵢₚ²=Σᵢ wᵢ²[i,h]σ²∥Wₗ∥₂² σ².

LUT. The LUT evaluation outputs a LWE ciphertext that decrypts to ΔF(m+e₁)+e₂ for inner product m. And the LUT input is the above ciphertext ipₕ of inner product. First find e₁, which is the error of look-up index.
By the present LUT algorithm, (a′, b′) has decryption result b′+(a′, s)=┐2n′m/q┘+e. By the central limit heuristic, e has variance 4n′²σᵢₚ²/q²+(∥s∥₂²+1)/12, where the second term is from the rounding ┌·┘. Note that ciphertext is generated from uniformly random distribution, thus the loss of ┌·┘ is from U[−1/2, 1/2].
Next, note the definition of ƒ's coefficients, the above error e is scaled up by a factor of q/(2n′), which results in an error with variance a σᵢₚ²(∥s∥+1)/(48n′²). Also note that the error of [2n′m/q] is scaled up by a factor of q/(2n′), this error has variance (1/12)×q²/(4n′²) if assuming the loss of ┌·┘ is from U[−1/2, 1/2]. Summing up both parts, the following equation can be obtained:

$$var ( {e}_{1} ) = {σ}_{ip}^{2} + {q}^{2} ( {‖ s ‖}_{2}^{2} + 2 ) / ( 48 {n}^{′2} ) = {‖ {w}_{l} ‖}_{2}^{2} {σ}^{2} + {q}^{2} ( {‖ s ‖}_{2}^{2} + 2 ) / ( 48 {n}^{′2} ) .$$

Next, proceed to find e₂. In each step j, the external product is computed as follows:

$$AC += ( {X}^{{a}^{′} [ j ]} - 1 ) {EK}_{j , +} + ( {X}^{- {a}^{′} [ j ]} - 1 ) {EK}_{j , -} ) ⊙ AC .$$

It can also be derived that given polynomials a, b∈R_{n′}, whose variances of the coefficients are σₐ² and σ_{b}² respectively, then:
the variance of coefficients of polynomial a+b is σₐ²+σ_{b}²;
the variance of coefficients of polynomial ab is n′σₐ²σ_{b}².

Based on the above, various example embodiments are able to find the variance of polynomial calculations. For the sake of simplicity, it will be understood by a person skilled in the art that the variance of a polynomial refers the variance of the coefficients of the polynomial.
Let RGSWⱼ=(X^{a′[j]}− 1)EK_{j,+}+(X^{-a′[j]}− 1)EK_{j,-}). First, various example embodiments find the variances of the coefficients of the polynomial in each slot of RGSWⱼ. By our definition of algorithm, EK_{j,+} and EK_{j,-} have the same error variance (σ_{LUT}²) in each slot. Then note that (X^{a′[j]}− 1)EK_{j,+} is a sum of (X^{a′[j]}− 1)EK_{j,+} and −EK_{j,+}. They both have variances σ_{LUT}². The other part (X^{-a′[j]}−1)EK_{j,-} is the same, so the variance in each slot of (X^{a′[j]}−1)EK_{j,+}+(X^{a′[j]}−1)EK_{j,-} is 4σ_{LUT}².
Suppose in step j, AC=(aⱼ, bⱼ) where both aⱼ and bⱼ are polynomials in R_{n′,q}. Given decomposition base B, they have decomposition:

$${a}_{j} \to ( {\hat{a}}_{0} , {\hat{a}}_{1} , ... , {\hat{a}}_{d - 1} ) , {b}_{j} \to ( {\hat{b}}_{0} , {\hat{b}}_{1} , ... , {\hat{b}}_{d - 1} )$$

where aⱼ=Σᵢ₌₀^{d-1}Bⁱ âᵢ, bⱼ=Σᵢ₌₀^{d-1}B¹ \hat{b}ᵢ. It can also be written:

$${RGSW}_{j} = ( β , α ) = ( ( β [ 0 ] , β [ 1 ] , ... , β [ d - 1 ] ) , ( α [ 0 ] , α [ 1 ] , ... , α [ d - 1 ] ) ) .$$

By definition of the above-mentioned RGSW, each β[j] or α[j] is a pair of polynomials. Then:

$${RGSW}_{j} ⊙ AC = {a}_{j} ♢α + {b}_{j} ♢β = {\sum }_{i = 0}^{d - 1} ( {\hat{a}}_{i} α [ i ] + {\hat{b}}_{i} β [ i ] )$$

Since all âⱼ and \hat{b}ⱼ have B-bounded coefficients, the variance of each slot in RGSWⱼ⊙AC is bound by:

$$d \times 2 \times n {β}^{2} \times ( 4 {σ}_{LUT}^{2} ) = 8 {n}^{′} d {β}^{2} {σ}_{LUT}^{2}$$

Finally, Wⱼ=(X^{a′[j]}− 1)EK_{j,+}+(X^{-a′[j]}−1)EK_{j,-}) in each step j has the same distribution, and thus has the same error variance. The total variance in n steps is var(e₂)=8nn′dβ_{LUT}².

Key Switch. By the above-mentioned definitions of Key-Switching key {SKⱼ} and RL\tilde{W}E, each SKⱼ has d RLWE ciphertexts, each of which has error of variance σ_{KS}². The error e_{KS} is from Σⱼ₌₀^{n′/n-1} ãⱼ⋄SKⱼ. Similarly as the ⋄ operation in the LUT part, note that deg(ã₁)=n, the variance of e_{KS} is bounded by:

$${n}^{′} / n \times {nB}_{KS}^{2} {σ}_{KS}^{2} = {n}^{′} {B}_{KS}^{2} {σ}_{KS}^{2} .$$

Rounding. Suppose the rounding factor is z, simply round down the variance by a factor of z². To round the ciphertext to integer, [j] results in an additional variance of var(e_{RD}) (∥s∥2+1)/12.

Assuming that F(·) is L-lipschitz and then|F(m+e₁)−F(m)|≤L|e₁|. Next, |e₁|, |e₂| and |e_{KS}| can be bounded w.h.p. by O(\sqrt{var(e₁)}) under central limit heuristic. To sum up, after scaling down Δ, the error between F(m) and F(m+e₁)+e₂/Δ+e_{KS}/Δ+e_{RD} is bounded by:

$$O ( L \sqrt{var ( {e}_{1} )} + \frac{\sqrt{var ( {e}_{2} )} + \sqrt{var ( {e}_{KS} )}}{Δ} + \sqrt{var ( {e}_{RD} )} ) = O ( L \sqrt{{‖ {w}_{l} ‖}_{2}^{2} {σ}^{2} + {q}^{2} ( {‖ s ‖}_{2}^{2} + 2 ) / ( 48 {n}^{′2} )} + \frac{\sqrt{8 {nn}^{′} d {β}^{2} {σ}_{LUT}^{2}} + \sqrt{{n}^{′} {B}_{KS}^{2} {σ}_{KS}^{2}}}{Δ} + \sqrt{( {‖ s ‖}_{2}^{2} + 1 ) / 12} )$$

In addition, the error variance of the LWE ciphertext that output is given to the next layer:

$$= {σ}_{l + 1}^{2} \leq ( {L}^{2} var ( {e}_{1} ) + \frac{var ( {e}_{2} ) + var ( {e}_{KS} )}{{Δ}^{2}} + var ( {e}_{RD} ) ) \leq ( {L}^{2} {‖ {w}_{l} ‖}_{2}^{2} {σ}^{2} + {q}^{2} ( {‖ s ‖}_{2}^{2} + 2 ) / ( 48 {n}^{′2} ) + \frac{8 {nn}^{′} d {β}^{2} {σ}_{LUT}^{2} + {n}^{′} {B}_{KS}^{2} {σ}_{KS}^{2}}{{Δ}^{2}} + ( {‖ s ‖}_{2}^{2} + 1 ) / 12 ) .$$

### Efficiency Analysis

The efficiency of the present FHE scheme (or the system thereof) will now be analysed, along with a comparison with other conventional schemes. The computations of inner-product, rounding and key switching are very fast (e.g., take less than 0.01 s in test). The LUT algorithm is the slowest part in the present system, so various example embodiments focus on the analysis on the LUT algorithm. Among all operations in LUT, external product is the most expensive operation, since it includes a large number of polynomial multiplications, whose complexity is 0(n log n). (X^{a}−1)·p (whereby p is a polynomial, denoted by a quick multiplication) is another frequently used operation in LUT algorithm, whose complexity is 0(n) in implementation. FIG. 29 depicts a table (Table 1) showing a comparison of the above-mentioned first, second and third example LUT algorithms (1-bit LUT algorithm shown in FIG. 25, 2-bit LUT algorithm for single layer shown in FIGS. 26 and 2-bit LUT algorithm for multiple layers shown in FIG. 27, respectively) according to various example embodiments of the present invention, along with conventional FHE-DiNN (e.g., disclosed in Bourse et al., “Fast homomorphic evaluation of deep discretized neural networks”, In Annual International Cryptology Conference, pages 483-512. Springer, 2018) and PEGASUS (e.g., disclosed in Lu et al., “Pegasus: Bridging polynomial and non-polynomial evaluations in homomorphic encryption”, In 2021 IEEE Symposium on Security and Privacy (SP), pages 1057-1073. IEEE, 2021) schemes, whereby n denotes the dimension of LWE vectors and l denotes the length of one decomposed RGSW ciphertext.

It can be observed that compared with FHE-DiNN, the number of external products and polynomial multiplications in both the example 2-bit LUT algorithms according to various example embodiments are same. However, with respect to the choice of functions, the present system supports a large variety of types of functions, such as ReLu, and a number of widely-used functions in neural network, while FHE-DiNN only support sign function. And since all parts of the present system run on integer, a faster polynomial multiplication algorithm (NTT) can be employed. In contrast, FHE-DiNN runs on floating numbers and the polynomial multiplication algorithm used is FFT. Therefore, in practice, the external product according to the present FHE scheme is faster than FHE-DiNN.

Compared with PEGASUS, although PEGASUS and the three example LUT algorithms according to various example embodiments have a large number of choices on the functions, but the number of external product in the present system is 2-4 times less than PEGASUS. Therefore, in practice, as a benefit from the customized design of the present FHE scheme, the n is smaller than PEGASUS.

Among the three example LUT algorithms (or candidates) of the present FHE scheme, it can be seen that the 2-bit LUT algorithm for single layer is the best one in both efficiency and storage. If the whole network has single hidden layer, or if the private network of the hybrid privacy-preserving neural network model has single hidden layer, the 2-bit LUT algorithm for single layer may thus be taken as an optimal choice. For the 1-bit LUT algorithm and 2-bit LUT algorithm for multiple layers, it is hard to see which one is better. The number of polynomial multiplications in the former is twice more than the latter, but the number of quick multiplications in the former is 4 times less than the latter. In experiments conducted, these 2 example LUT algorithms achieve similar running time.

### Evaluation Results

Performances of the present FHE scheme (or the system thereof) will now be discussed according to various example embodiments of the present invention. All of the experiments conducted ran on: (1) lab PC: Desktop with Intel(R) Xeon(R) W-2123 CPU @3.60 GHz; (2) Google Cloud platform: 1 physical CPU with 8 cores @2.4 GHz. The security level is at least 80 bits. It was found that the present FHE scheme took about 70 ms in calculating one node and one activation function in the neural network. It is the state-of-the-art result for this problem.

### Test in Basic Privacy-Preserving Neural Network Model

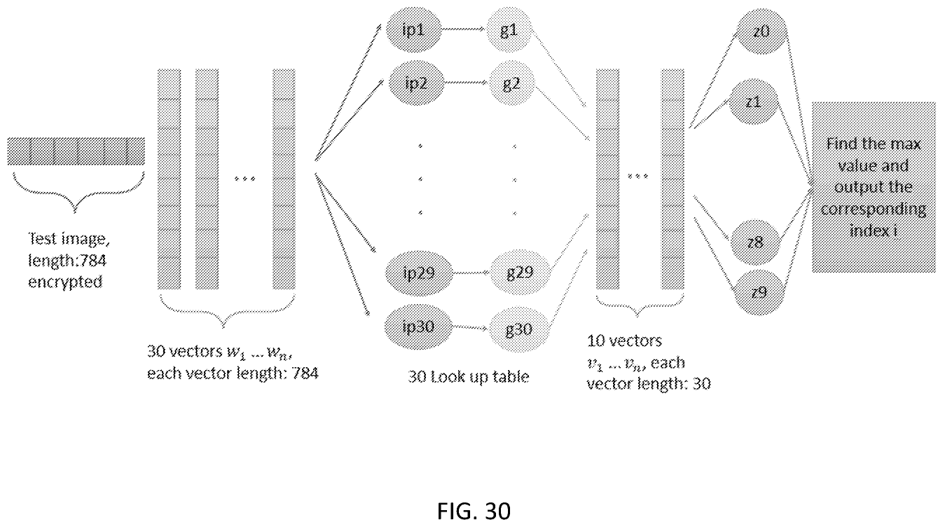

The basic privacy-preserving neural network system was first tested in BP (back propagation) network on the MNIST (Modified National Institute of Standards and Technology) optical character recognition tasks. The BP network has one hidden layer and 30/100 nodes. FIG. 30 depicts a schematic drawing of the structure of the BP network with 30 nodes. Firstly, the training of the neural network over data in the plaintext is described, and secondly, the results obtained when evaluating the network over encrypted inputs are provided.

Pre-processing the MNIST dataset. MNIST dataset consists of 28*28 black and white hand writing digits, so all input image can be binarized. There are two ways to binarize the image. For each point of the image (784 points totally), a value of 1 is set if the original value is >0 or a value of 0 is set otherwise. Therefore, the input image is a vector \vec{x}∈{0,1}⁷⁸⁴. Then, the two networks (i.e., the first BP network with 30 hidden nodes and the second BP network with 100 hidden nodes) are trained with 60,000 images and the present trained network is tested with another 10,000 images. The prediction accuracy in plaintext is 94.80%.

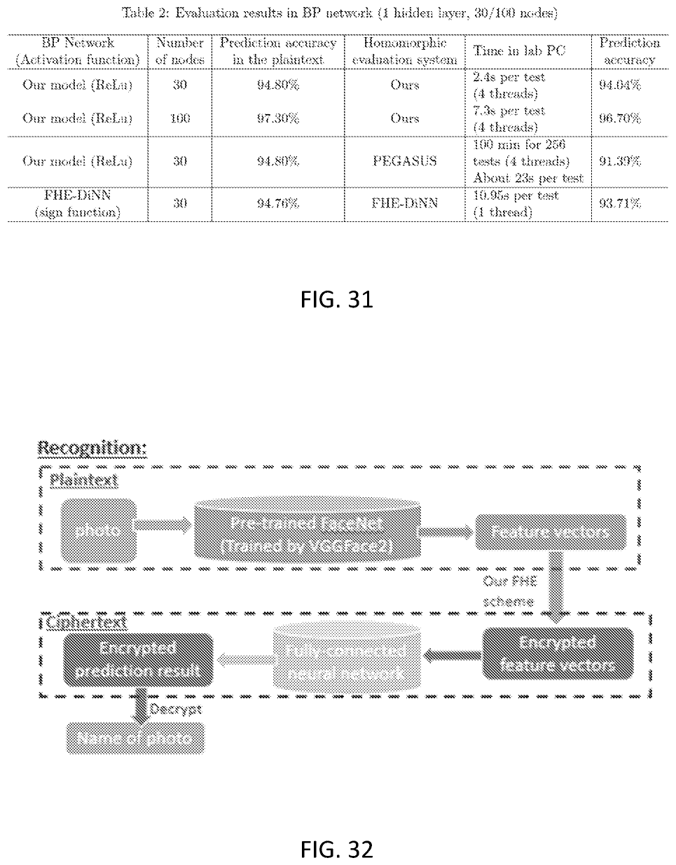

Evaluation results. FIG. 31 shows a table (Table 2) presenting the evaluation results in the first and second BP networks (1 hidden layer and 30/100 nodes). The first two rows of Table 2 show the results obtained from evaluating the present homomorphic evaluation system in 30 and 100 nodes. It can be seen that the prediction accuracy over encrypted inputs only lose around 0.5% compared to the prediction accuracy in the plaintext.

The third row shows the results obtained from evaluating PEGASUS in the first BP network (1 hidden layer and 30 nodes). Since it is too costly, only the first 512 images were tested. The last row shows the results obtained from evaluating FHE-DiNN in their own model. Since the activation function in their scheme is a sign function, the first or second BP network models cannot be used to test their system directly. Therefore, their system in the model which they provided in FHE-DiNN was tested. For example, it can be seen that for experiments in the BP network with 1 hidden layer and 30 nodes, the present homomorphic evaluation system achieves better results in both prediction accuracy and time.

### Test in Hybrid Privacy-Preserving Neural Network Model

The present hybrid privacy-preserving neural network system is now tested on face recognition task. In this experiment, a hybrid network was built to perform face recognition in a group of people. Training and test datasets were established, which include photos of 10 people. The test dataset is different from the training dataset.

A pre-trained FaceNet (trained by VGGFace2) was used as the open network and a private fully connected network was trained on the training dataset by freezing all parameters in pre-trained network. The present system was then implemented based on the present customized FHE scheme according to various example embodiments and was tested.

Pre-trained FaceNet runs in plaintext and outputs a feature vector with a length of 512. The private fully connected network has two layers and runs in ciphertext. Parameters in the first layer are in a 512×30 matrix. The first layer computes 30 inner-products and outputs a vector with a length of 30. Parameters in the second layer are in a 30×10 matrix. The second layer computes 10 inner-products and outputs 10 values. Finally, the system outputs the corresponding name of the max value. FIG. 32 depicts a schematic diagram illustrating an example structure of the recognition network according to various example embodiments of the present invention.

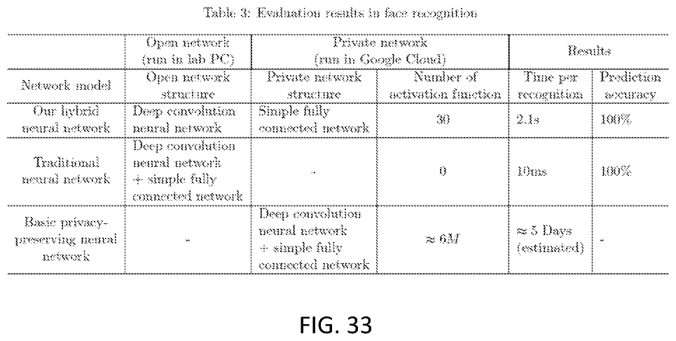

Evaluation results. FIG. 33 shows a table (Table 3) presenting the evaluation results obtained in the face recognition task. In this table, three neural network models for face recognition were compared, namely, (1) the present hybrid neural network model, whereby the open network runs in plaintext and the private network runs in ciphertext; (2) a traditional neural network model, which is not privacy-preserving and the whole network runs in plaintext; and (3) the basic privacy-preserving neural network, whereby the whole network is privacy-preserving and runs in ciphertext.

It can be observed that the traditional neural network is very fast, but it does not address the privacy problem. The basic privacy-preserving neural network is good at privacy protection, but it is too slow to be applied to practical applications in the real world. As an example comparison, the present hybrid neural network according to various example embodiments only needs 2.1 seconds per recognition (10 ms for open network and 2.09 s for private network), while the basic privacy-preserving neural network needs 5 days in the same cloud environment. Therefore, the present hybrid neural network model achieves a good balance between privacy protection and efficiency, and can be applied to practical applications in the real world.

### Test on the Noise in Multiple Layers

After showing that the present system performed well in single hidden layer neural network, multiple layers will now be analyzed. The key to achieve good results in multiple layers is to ensure that the noise is always in a suitable range. A theoretical analysis on the growing of noise has been described hereinbefore, and experimental results thereof will now be discussed.

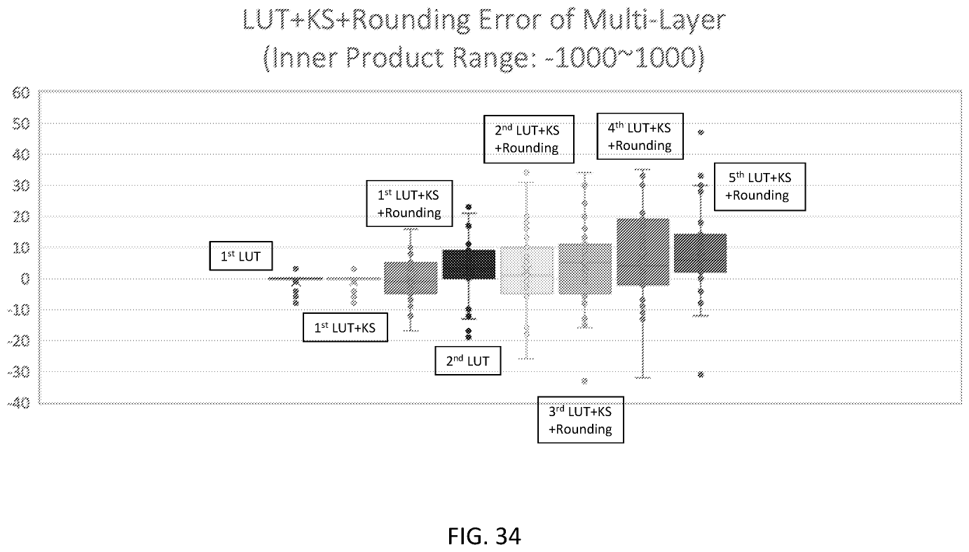

The noise is growing in two steps. The first is in the inner-product computation. In this part, the growing of noise is linear and easy to control by choosing suitable parameters. Therefore, focus is provided on the second step: look-up table (LUT), key switching (KS) and rounding. For example, the evaluation function in LUT is ReLu. The program was instructed to run one inner-product computation and then to perform LUT+KS+Rounding operations five times continuously. FIG. 34 depicts a plot of the test results on the noise growing in LUT+KS+Rounding operations.

FIG. 34 shows the difference between the result of “i-th LUT+KS+Rounding” and the real value. 0 means that the result in “i-th LUT+KS+Rounding” is the same as the real value, which means no error exists. From FIG. 34, it can be seen that most of points fall in (−5, 20), which is relatively small compared to the inner-product range (−1000, 1000).

### Further Optimization of the FHE Scheme for Non-Linear Functions

Various example embodiments provide a further enhanced and efficient design for LUT-based non-linear function evaluation. In particular, the design of a privacy-preserving neural network model has been described hereinbefore according to various example embodiments. The privacy-preserving neural network model advantageously addresses the privacy issues in machine learning service. For example, a user may encrypt data before sending it to the machine learning server. The cloud server may then perform neural network computations on ciphertext and return an encrypted prediction result. Accordingly, both the user's data and the prediction result can be protected. However, as explained hereinbefore, homomorphic computations on encrypted data is much slower than computations on plaintext, especially for computations of non-linear functions (e.g., activation function in neural networks). Therefore, applications of homomorphic calculation by FHE have been very limited.

As described hereinbefore, to enhance efficiency, various example embodiments provide homomorphic LUT algorithms (e.g., as described hereinbefore with reference to FIGS. 25 to 25) for evaluating non-linear functions. In this regard, the LUT algorithms are each configured to encode the “Table” of values of the non-linear function into a polynomial, so that a ciphertext can be used to locate the position of the desired output without decryption. In this regard, various example embodiments further improves the LUT algorithms, which may thus be referred to as improved LUT algorithms. As a result, for example, the improved system (i.e., with an improved LUT algorithm) only takes 0.73 seconds per face recognition, compared to 2.1 seconds achieved by the present system as described hereinbefore according to various example embodiments.

An improved LUT algorithm will now be described in further detail according to various example embodiments of the present invention, which includes two main improvements, namely, RNS (residue numeral system) polynomial multiplications and modulo function.

RNS Polynomial multiplications. Various example embodiments note that the LUT algorithm comprises a huge amount of polynomial multiplications and additions, and multiplication is much slower than addition. In this regard, various example embodiments use number-theoretic transform (NTT) multiplication algorithm (as will be described in further detail later below) to speed up the polynomial multiplication. In general, one NTT multiplication includes: first turn the two polynomials into two vectors, then perform a multiplication between the two vectors (position-wise multiplication), and finally turn the resulted vector into a polynomial, which is exactly the result of polynomial multiplication. The vector form of one polynomial may be referred to hereinafter as its RNS form. In particular, various example embodiments advantageously provide an improved LUT algorithm configured to, for each of a plurality of polynomial multiplication operations therein, perform polynomial multiplication of polynomials in RNS form.

Various example embodiments advantageously do not treat one NTT multiplication computation as a black box. In particular, various example embodiments note that many transformations from vector to polynomial, or from polynomial to vector, can be removed to reduce the time cost. For example, in many part of the LUT algorithm, computations can be completed only in the form of vector, and no transformations are needed. Meanwhile, the results are still correct.

Modulo function. In the present FHE encryption scheme, all computations are performed in integer ring [symbol] _{q}:= [symbol] /q [symbol] where q is a prime number. That is to say, many modulo q functions have to be performed to keep things in, [symbol] q during the LUT algorithm. A naive approach is to perform the modulo q function after each step, like many existing work on FHE scheme. However, various example embodiments note that modulo q function is slow, compared with add and multiply function between integers. For example, it will be extremely slow when q is large (say, hundreds of bits). Therefore, various example embodiments provide the following optimization on the modulo q function.
Design different modulo function after add/multiply/polynomial-vector transformation. It can be imagined that after add function, the modulo q process is simpler than that after multiply function. Therefore, using different modulo functions in different cases helps significantly in improving efficiency than using one same modulo function.
Reduce the number of modulo function used. This case can be illustrated by a simple equation: a mod q+b mod q≡(a+b) mod q. After some steps, some modulo q functions can be safely removed and continue computing. For example, this detailed modification may help to reduce half number of modulo q functions.

Accordingly, the improved system is significantly faster. For example, compared to the present system as described hereinbefore according to various example embodiments, the number of NTT/INTT transformation is a third of before, and the number of modulo calculation is a half of before, both of which help save a significant amount of time. For example, the total time for one face recognition is reduced to 0.73 seconds by the improved system, compared to 2.1 seconds achieved by the present system as described hereinbefore according to various example embodiments.

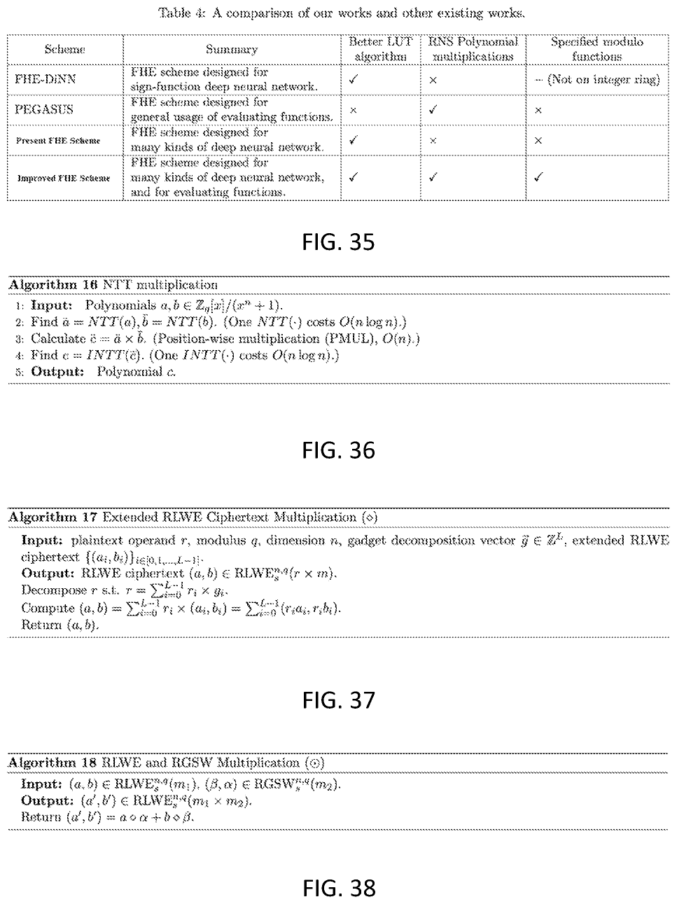

FIG. 35 shows a table (Table 4) comparing the improved FHE scheme, the present FHE scheme and conventional FHE schemes. For example, the following aspects of improvements are achieved, especially in relation to the implementation of LUT algorithm for evaluating non-linear functions. Detailed evaluation results, including time cost, will be provided later below.
Better LUT algorithm: the improved LUT algorithm is optimized such that the number of polynomial multiplication needed is half of before.
RNS Polynomial multiplications: use RNS form instead of polynomial form in multiplication. In this case, many transformations between vector form and polynomial form can be removed.
Specified modulo functions: using different modulo functions in different cases and remove modulo function whenever possible.

### Number-Theoretic Transform (NTT) Multiplication

In the present encryption scheme, almost all computations involve high-degree polynomial multiplications. Naive polynomial multiplication costs O(n²) time, where n is the degree of polynomials. In field [symbol] or [symbol] using Faster Fourier Transforms (FFT) for polynomial multiplication is a common technique. It changes the time cost from O(n²) to O(n log n), and this will have significant improvement when n is large, especially in the area of cryptography. Various example embodiments only consider integers in cryptography and a variant of FFT algorithm is used on finite field, which is called NTT.

The basic idea of NTT is that for some appropriately chosen prime q, [symbol] _{q}[x]/(xⁿ+1) and [symbol] _{q}ⁿ are isomorphic. Therefore, a mapping TT(·): [symbol] [x]/(xⁿ+1)→ [symbol] _{q}ⁿ can be defined which turns a polynomial into an integer vector. By definition of isomorphic, an inverse mapping is INTT(·): [symbol] _{q}ⁿ→ [symbol] _{q}[x]/(xⁿ+1), which turns a vector back to the polynomial. Also by the definition of isomorphic, the following can be obtained:

$$NTT ( a + b ) = NTT ( a ) + NTT ( b ) .$$

$$NTT ( a \times b ) = NTT ( a ) \times NTT ( b ) .$$

Here, the multiplication of vectors is position-wise multiplication. The vector NTT(a) is called RNS form of polynomial a, and a is used to represent it in the following algorithm. A NTT multiplication algorithm is shown in FIG. 36 according to various example embodiments. In particular, FIG. 36 shows an example algorithm (Algorithm 16) for the NTT multiplication according to various example embodiments of the present invention. In particular, a polynomial c is produced by the NTT multiplication based on polynomials a and b. The time cost is 20(n log n)+O(n)+O(n log n)=O(n log n), which is better than the naive O(n²).

### Ciphertext Operations

The LUT algorithm is made up by different kinds of ciphertexts and their operations.
RLWE ciphertext: it is a pair of polynomials (a, b) such that message m=as +b+e, where s is the secret key and e is a generated noise.
Extended RLWE ciphertext: it is a set of RLWE ciphertexts {(aᵢ, bᵢ)}ᵢ₌₀^{L-1}, given a same key s and a gadget vector \vec{g}=(g₀, . . . , g^{L-1})∈ [symbol] ^{L-1}. We have (aᵢ, bᵢ)∈RLWEₛ^{n,q}(gᵢm), i=0, . . . , L−1.
RGSW ciphertext: it includes extended RLWE ciphertext of m and extended RLWE ciphertext m×s.

FIG. 37 shows an example algorithm (Algorithm 17) for the extended RLWE ciphertext multiplication (⋄) according to various example embodiments of the present invention. In particular, a RLWE ciphertext (a, b) is produced by the extended RLWE ciphertext multiplication based on plaintext operand r, modulus q, dimension n, gadget decomposition vector \vec{g} and extended RLWE ciphertext {(aᵢ, bᵢ)}. FIG. 38 shows an example algorithm (Algorithm 18) for RLWE and RGSW multiplication (⊙) according to various example embodiments of the present invention. In particular, a RLWE ciphertext (a′, b′) is produced by the RLWE and RGSW multiplication based on a RLWE ciphertext (a, b) and a RGSW ciphertext (β, α).

### Reduce the Number of NTT/INTT Transformations

Various example embodiments provide two methods for reducing the number of NTT/INTTs in the LUT algorithm, namely, a general method that can be applied in any cases and a method that is designed for the neural network where very large modulus is necessary, such as hundreds of bits. In practical scenario, suitable method can be chosen according to the particular problem (or prediction task of interest) and neural networks.

### General Method to Reduce Number of NTT/INTTs in LUT

The 2-bit look-up table evaluation for single hidden layer algorithm (Algorithm 14) shown in FIG. 26 is used as an example present LUT algorithm to show how to reduce the number of NTT/INTTs therein to obtain an improved LUT algorithm, according to various example embodiments of the present invention. Write R_{n,q}= [symbol] _{q}[x]/(xⁿ+1).

First, the number of NTT/INTTs in one LUT is counted. d is used to denote that in the beginning of each external product ⊙, each polynomial in AC is decomposed to d polynomials. Since ‘quick multiplication’ is already used to compute (X^{a′[2j]+a′[2j+1]}−1)EK_{j,0}, (X^{a′[2j]}−1)EK_{j,1} and (X^{a′[2j+1]}−1)EK_{j,2}, the NTT multiplications only appear in ⊙. One ⊙ includes 4d NTT polynomial multiplications. So one LUT calculation includes 4d (n/2)=2dn NTT polynomial multiplications. Each NTT polynomial multiplication includes 3 NTT/INTT transformations, so one LUT has 6dn NTT/INTT transformations.

A method is to store EK_{j,0}, EK_{j,1} and EK_{j,2} in RNS form when generating them. Such evaluation keys are generated in the initialization phase and can be used repeatedly. When generating the evaluation keys, NTT transformations can be performed after RGSW encryption to convert them into RNS form and store them.

In LUT calculation, when calculating (X^{a′[2j]+a′[2j+1]}−1)EK_{j,0}+(X^{a′[2j]}−1)EK_{j,1}+(X^{a′[2j+1]}−1)EK_{j,2}, NTT transformation is first performed on X^{a′[2j]+a′[2j+1]}−1, X^{a′[2j]}−1 and X^{a′[2j+1]}−1. Then, position-wise multiplications and additions are performed. The output of this part is 4d RNS form polynomials.

Next, the calculation of ⊙. The left side of ⊙ is already in RNS form. So various example embodiments first decompose the right side from 2 polynomials to 2d polynomials and do NTT transformations 2d times. The other calculations in ⊙ can be performed by position-wise multiplications and additions. Now the output of ⊙ is 2 RNS form polynomials. 2 INTT transformations are applied on them to obtain 2 regular polynomials.

Therefore, in each loop, only 3+2d NTT transformations and 2 INTT transformations are required. So one improved LUT only has dn+2.5n NTT/INTT transformations. For example, if assuming n=512 and d=2, then the number of NTT/INTT transformations reduced from 6144 to 2304.

Further Improvements on Neural Network with Large Modulus

When it is necessary to use hundreds bits modulus Q, a well known technique is to set Q as a product of L distinct and machine-word-sized primes: Q=Πᵢ₌₀^{L-1}qᵢ. Each qᵢ is also appropriate chosen so that NTT multiplication can be applied. The problem of this decomposition is, when modulus is very large, the multiplications and mod algorithm on computer/server become very slow. Using machine-word-sized is many times faster.

By Chinese remainder theorem (CRT), R_{n,Q} and =Πᵢ₌₀^{L-1}R_{n,q}_{ᵢ} are isomorphic, which means that for each polynomial ƒ in Rⁿ,Q, it is equivalently L polynomials in R_{n,qi},i=1, . . . , L−1, so its RNS form ƒ̅ is L vectors in [symbol] _{q}ⁿ, i=0, . . . , L−1

Recall in Algorithm 13 in FIG. 26, in each loop, the following is computed:

$${AC}_{i + 1} += [ ( {X}^{{a}^{′} [ 2 i ] + {a}^{′} [ 2 i + 1 ]} - 1 ) \cdot {EK}_{i , 0} + ( {X}^{{a}^{′} [ 2 i ]} - 1 ) {EK}_{i , 1} + ( {X}^{{a}^{′} [ 2 i + 1 ]} - 1 ) {EK}_{i , 2} ] ⊙ {AC}_{i}$$

For simplicity, the above equation can be expressed as:

$$( {X}^{{a}^{′} [ 2 i ] + {a}^{′} [ 2 i + 1 ]} - 1 ) \cdot {EK}_{i , 0} + ( {X}^{{a}^{′} [ 2 i ]} - 1 ) {EK}_{i , 1} + ( {X}^{{a}^{′} [ 2 i + 1 ]} - 1 ) {EK}_{i , 2} = {EK}_{i}$$

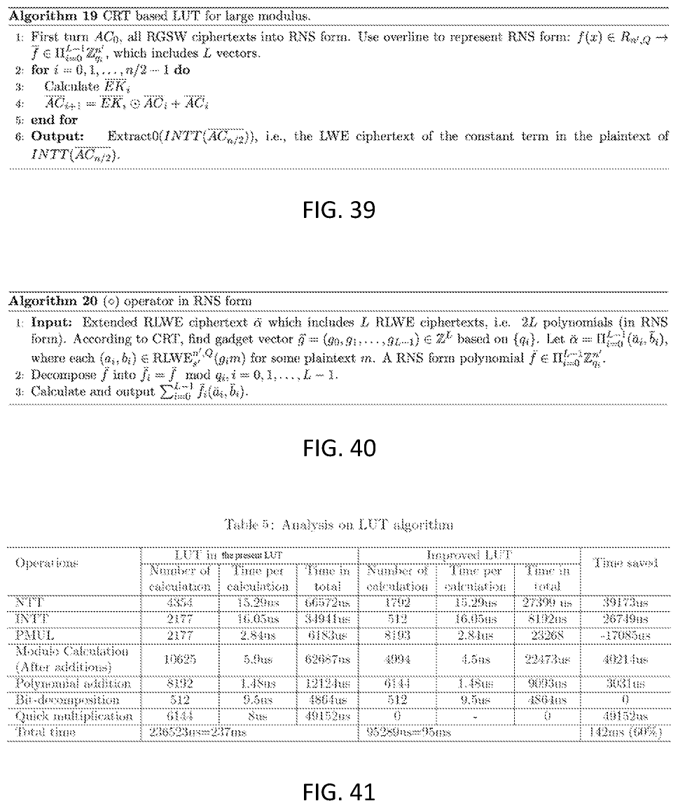

FIG. 39 shows an example algorithm (Algorithm 19) for CRT based LUT for large modulus according to various example embodiments of the present invention.

If E̅K̅ᵢ=(α̅ᵢ, β̅ᵢ) and A̅C̅ᵢ=(āᵢ, b̅ᵢ), then A̅C̅ᵢ₊₁=E̅K̅ᵢ⊙A̅C̅ᵢ=α̅ᵢ [symbol] α̅ᵢ+β̅ᵢ [symbol] b̅ᵢ.

In this regard, various example embodiments define (O) operator as shown in FIG. 40. In particular, FIG. 40 shows an example algorithm (Algorithm 20) for (O) operator in RNS form according to various example embodiments of the present invention. For example, without this optimization, 2 NTT and one INTT are required per multiplication. In this regard, there are a large number of multiplications in the loops so there are a large number of NTT/INTTs. In contrast, by using this approach, it is only required NTTs at the beginning of loop and INTTs at the end of loop. Therefore, the number of NTT/INTTs can be significantly reduced.

### Other Improvements

Besides reducing the number of NTT/INTTs, various example embodiments provide other improvements in the LUT algorithm.

Optimize modulo calculation. Various example embodiments note that the modulo calculation after addition is much easier than the modulo calculation after multiplication. Furthermore, various example embodiments note that this is because the size of coefficients grows slowly in addition. For example, having two 59-bit coefficients c₁ and c₂, then c₁+c₂ is at most 60-bit, while c₁×c₂ could be 118-bit. So two modulo calculation functions are provided, namely, one modulo calculation function for addition and another modulo calculation function for multiplication. For example, as explained above, outputs of different operations can have different sizes. In this regard, to improve efficiency according to various example embodiments, in modulo calculation after addition, subtraction is performed instead of computing reminder, while in modulo calculation after multiplication, computing reminder is more efficient.

Reduce the number of modulo calculation. The modulo calculation may be separated from the polynomial addition. In most works, modulo calculation is followed by every polynomial addition, which means that at any time, when a polynomial addition is performed, then a modulo calculation will be performed. However, various example embodiments note that many modulus calculations are not necessary. For example, in the above-mentioned face recognition experiment, the modulus is a 59-bit prime. In contrast, in the code according to various example embodiments, 64-bit integer data type is used to store the coefficients. From AC+=((X^{a′[2j]+a′[2j+1]}−1)EK_{j,0}+(X^{a′[2j]}−1)EK_{j,1}+(X^{a′[2j+1]}−1)EK_{j,2})⊙AC, it can be seen that only one modulo calculation is required after two additions in the left side of ⊙. Similarly, by the definition of ⊙ (Algorithm 18) and ⋄ (Algorithm 17), only one modulo calculation is required after 2-3 additions. As a result, in the face recognition experiment, for example, 10625 modulo calculations were required but only 4994 modulo calculations are required in the improved LUT algorithm according to various example embodiments.

### Efficiency Analysis

The face recognition experiment is used as an example to demonstrate how much time can be saved according to various example embodiments of the present invention.

The present LUT algorithm and the improved LUT algorithm according to various example embodiments were executed and performance results (the time cost of various operations) are summarized in Table 5 shown in FIG. 41. The experiments were conducted in Google Cloud, e2-standard-16vcpu, single thread. From Table 5, it can be observed that compared to the present LUT algorithm, the improved LUT algorithm achieved a time saving of about 60%.

### Evaluation Results

Experiments on a face recognition task amongst a group of people were performed using the same recognition network as shown in FIG. 32 as described hereinbefore, except that the training and test dataset comprises photos of 30 people. In particular, the improved system according to various example embodiments is tasked on the face recognition task. The experiments were conducted in Google Cloud, e2-standard-16vcpu, multi-thread. A pre-trained FaceNet (trained by VGGFace2) was used as the open network and a private fully connected network was trained on the training dataset by freezing all parameters in the pre-trained network. The improved system was then implemented by the improved customized FHE scheme and was tested. Pre-trained FaceNet runs in plaintext and outputs a feature vector with a length of 512. The private fully connected network has two layers and runs in ciphertext. Finally, the system outputs the corresponding name of the max value.

Two tasks were considered in the experiments, namely, 1 to 1 face recognition and 1 to N face recognition. For the structure of the private network, for each task, both 1-layer fully-connected network and 2-layer fully-connected network were considered.

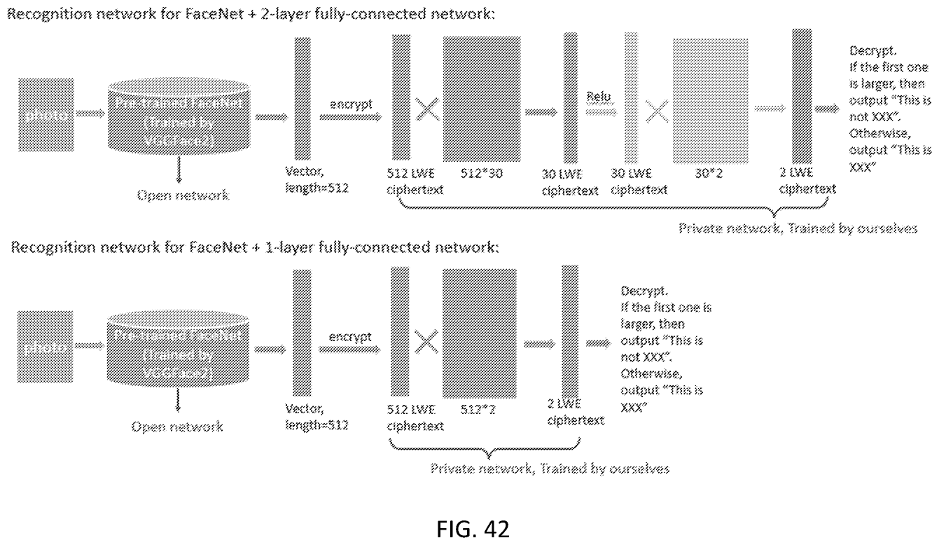

1 to 1 face recognition. For an input photo, the face recognition network is configured to output whether it is the one desired to be recognized. In the experiment, one person was first chosen from 30 people and set the person as the one to be recognized. For example, the face recognition network may output ‘This is XXX’ or ‘This is not XXX’. FIG. 42 depicts a schematic diagram showing an example structure of 1 to 1 face recognition network according to various example embodiments of the present invention.

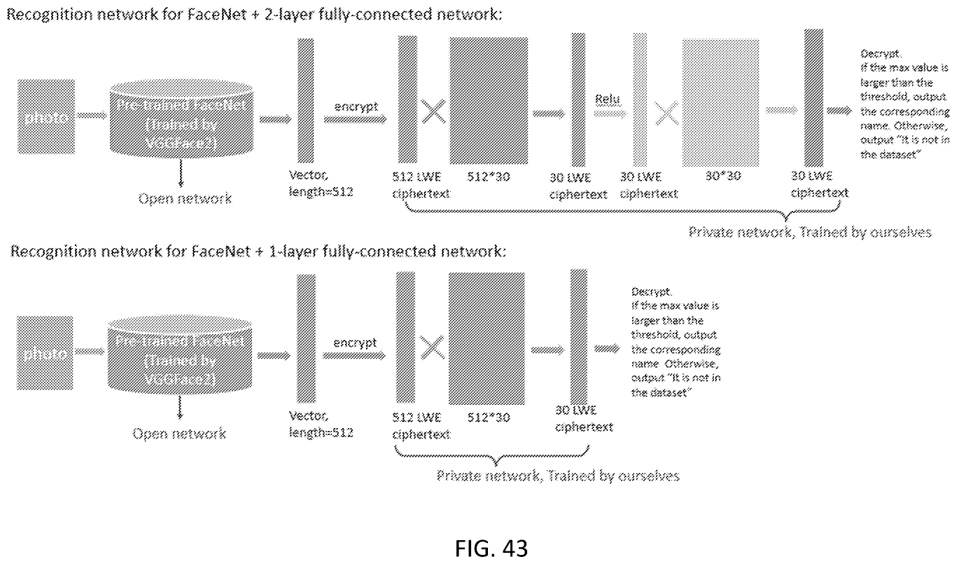

1 to N face recognition. For an input photo, the face recognition network may be configured to output the name of the input photo if it is in the dataset, otherwise output “It is not in the dataset”. In the experiment, when N=30, both time per recognition and accuracy were tested. When N=100, since collecting photos of 100 people is very time consuming, only the time was tested. FIG. 43 depicts a schematic diagram showing an example structure of 1 to N face recognition network according to various example embodiments of the present invention.

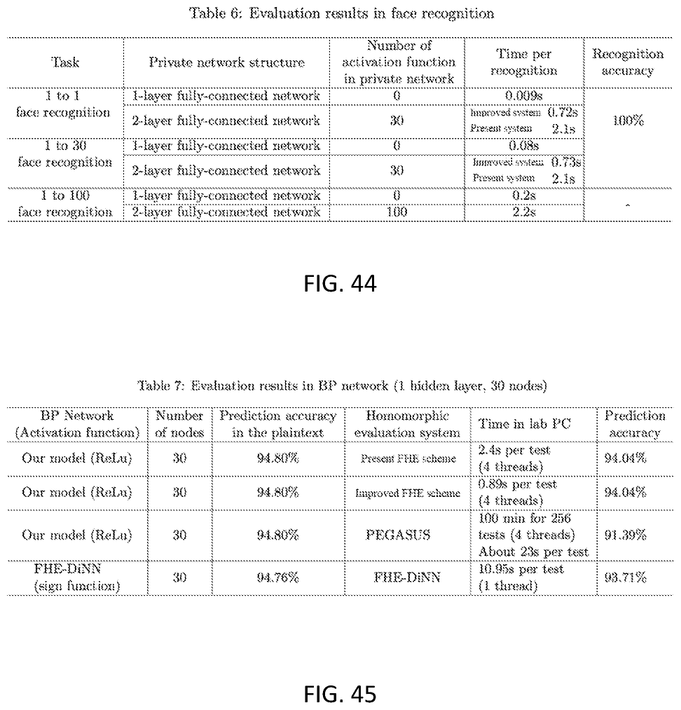

FIG. 44 shows a table (Table 6) presenting the evaluation results of the face recognition task according to various example embodiments of the present invention. It can be seen that the improved system according to various example embodiments only takes 35% of the time compared to the present system according to various example embodiments. The experimental results are consistent with the theoretical analysis described hereinbefore.

In order to compare with existing works, the improved system was also tested on MNIST dataset. FIG. 45 shows a table (Table 7) presenting the evaluation results of the improved system on MNIST dataset (using the BP network (1 hidden layer, 30 nodes)) according to various example embodiments of the present invention. The experiments were conducted on a lab PC: Desktop with Intel(R) Xeon(R) W-2123 CPU @3.60 GHz.

In Table 7, the first row shows the result of evaluating the present system. The second row shows the result of evaluating the improved system. The third row shows the results of evaluating PEGASUS in the above-mentioned first BP network model. Since it is too costly, only the first 512 images were tested. The last row shows the results of evaluating FHE-DiNN in their own network model. Since the activation function in their scheme is a sign function, the first or second BP network models cannot be used to test their system directly. Therefore, their system in the model which they provided in FHE-DiNN was tested. It can be seen that for experiments in the first BP network with 1 hidden layer and 30 nodes, both the present system and the improved system achieve better results, with the improved system achieving the best result.

### Applications

Example applications for the hybrid neural network model and customized FHE scheme according to various example embodiments will now be described.

For example, face recognition is one of the most popular techniques of machine learning. Face recognition is widely used in many applications, such as ID verification. For example, APPLE introduced Face ID on various devices as a bio-metric authentication successor to the Touch ID, a fingerprint based system. In this regard, privacy issues in face recognition has also drawn lots of attention. In order to be more accurate, the photos of the target group were used to train the neural network, which makes the parameters of the network sensitive. Also, for users, they may want to protect their personal privacy. Accordingly, the hybrid neural network model according to various example embodiments is both fast and protect such privacy. For example, an application scenario of the hybrid model is the door access system for an office/company. Instead of giving out access card to each staff, an office/company can implement door access system by using the hybrid face recognition model according to various example embodiments of the present invention.

As another example, a good and automatic image classification system can save people's time. Image classification can be used in many cases. For example, a large number of photos may be taken and then stored in a mobile phone, and it may be difficult to find a specific photo amongst all the photos stored. Therefore, it may be desired for photos to be classified by certain AI procedure, but without others being able to see the photos. In this regard, for example, with the help of excellent open-source pre-trained networks for image classification, a hybrid privacy-preserving photo classification system can be built according to various example embodiments of the present invention, which can add labels to photos without seeing the photo directly (i.e., without knowing the plaintext).

As a further example, nowadays, a large number of emails and SMS may be received. Many of them may be advertisement or spam mail, which may take a lot of time to check such messages everyday. Similar to the above image classification system, it may be desirable to have a privacy-preserving text classification system. In this regard, a hybrid privacy-preserving email/SMS classification system may be built according to various example embodiments of the present invention, which can add labels to text files without knowing the plaintext.

In addition, any privacy-preserving neural network which is based on homomorphic encryption can be speed up by the FHE scheme according to various example embodiments of the present invention.

Further, in various example embodiments, the LUT algorithm can be applied beyond neural network. For example, the FHE scheme according to various example embodiments is faster and can tolerate larger parameters and problem size. This helps to make the LUT results more accurate, and can be used as a homomorphic evaluator of many different non-polynomial functions, such as sigmoid, ReLU, sqrt, and so on.

In addition, from the algorithm aspect, the optimizations can also be applied to other lattice cryptography problems, which are usually based on polynomial calculations. For example, it can be checked if any part of the algorithm can be done in RNS form. This helps to reduce the number of NTT/INTT transformations. It can also be checked where add/multiply/modulo functions are needed, and where they can actually be omitted.

While embodiments of the invention have been particularly shown and described with reference to specific embodiments, it should be understood by those skilled in the art that various changes in form and detail may be made therein without departing from the scope of the invention as defined by the appended claims. The scope of the invention is thus indicated by the appended claims and all changes which come within the meaning and range of equivalency of the claims are therefore intended to be embraced.

1. A method of building a privacy-preserving neural network model using at least one processor, the method comprising:
performing first neural network operations using a non-private neural network of the privacy-preserving neural network model based on first input data in plaintext to produce first output data in plaintext, wherein the non-private neural network is pre-trained and learnable parameters of the non-private neural network are fixed while performing the first neural network operations;
encrypting the first output data from the non-private neural network using a homomorphic encryption method to produce first encrypted data; and
performing second neural network operations homomorphically using a private neural network of the privacy-preserving neural network model based on the first encrypted data to produce second encrypted data, wherein learnable parameters of the private neural network are trained while performing the second neural network operations.

2. The method according to claim 1, wherein the non-private neural network comprises one or more first convolution layers obtained from a pre-trained neural network.

3. The method according to claim 2, wherein the non-private neural network further comprises one or more first fully connected layers obtained from the pre-trained neural network.

4. The method according to claim 3, wherein the private neural network comprises one or more second fully connected layers.

5. The method according to claim 2, wherein the private neural network comprises one or more second convolution layers and one or more first fully connected layers obtained from the pre-trained neural network, and one or more second fully connected layers.

6. The method according to claim 5, wherein the one or more second convolution layers of the private neural network obtained from the pre-trained neural network are one or more lower convolution layers of the pre-trained neural network with respect to the one or more first convolution layers obtained from the pre-trained neural network.

7. The method according to claim 4, wherein the one or more second fully connected layers form a shallow fully connected network.

8. The method according to claim 2, wherein the pre-trained neural network is an open-source pre-trained neural network.

9. The method according to claim 1, wherein the first input data is labeled data from a training dataset.

10. The method according to claim 9, wherein the training dataset is a private dataset and is different from a dataset on which the pre-trained neural network was trained.

11. The method according to claim 1, wherein
said performing the second neural network operations comprises computing a plurality of non-linear functions, and
for each of the plurality of non-linear functions, the non-linear function is computed homomorphically using a look-up table (LUT) algorithm, wherein the LUT algorithm is configured to produce a polynomial having encoded therein a plurality of values of the non-linear function and to produce an output ciphertext corresponding to one of the plurality of values based on the polynomial and an input ciphertext to the LUT algorithm.

12. The method according to claim 11, wherein the plurality of values of the non-linear function are encoded into coefficients of the polynomial.

13. The method according to claim 12, wherein the plurality of non-linear functions are a plurality of activation functions.

14. The method according to claim 11, wherein
each fully connected layer of the private neural network comprises a plurality of nodes, and
for each fully connected layer of the private neural network, each of the plurality of nodes of the fully connected layer is configured to compute a respective non-linear function of the plurality of non-linear functions homomorphically using the LUT algorithm.

15. The method according to claim 14, wherein
said performing the second neural network operations further comprises computing a plurality of inner product functions homomorphically, and
for each fully connected layer of the private neural network, each of the plurality of nodes of the fully connected layer is configured to compute a respective inner product function of the plurality of inner product functions homomorphically based on an input ciphertext to the node and a weight matrix associated with the node to produce an output ciphertext, wherein the input ciphertext to the LUT algorithm for the node to compute the respective non-linear function homomorphically using the LUT algorithm corresponds to the output ciphertext of the respective inner product function.

16. The method according to claim 15, further comprising, for each of the plurality of nodes of the fully connected layer, controlling a size of the output ciphertext produced by the respective inner product function to have a predetermined number of bits.

17. The method according to claim 11, wherein the LUT algorithm is configured to, for each of a plurality of polynomial multiplication operations therein, perform polynomial multiplication of polynomials in residue numeral system (RNS) form.

18. A system for building a privacy-preserving neural network model,
the system comprising:
at least one memory; and
at least one processor communicatively coupled to the at least one memory and configured to:
perform first neural network operations using a non-private neural network of the privacy-preserving neural network model based on first input data in plaintext to produce first output data in plaintext, wherein the non-private neural network is pre-trained and learnable parameters of the non-private neural network are fixed while performing the first neural network operations;
encrypt the first output data from the non-private neural network using a homomorphic encryption method to produce first encrypted data; and
perform second neural network operations homomorphically using a private neural network of the privacy-preserving neural network model based on the first encrypted data to produce second encrypted data, wherein learnable parameters of the private neural network are trained while performing the second neural network operations.

19. A computer program product, embodied in one or more non-transitory computer-readable storage mediums, comprising instructions executable by at least one processor to:
perform first neural network operations using a non-private neural network of the privacy-preserving neural network model based on first input data in plaintext to produce first output data in plaintext, wherein the non-private neural network is pre-trained and learnable parameters of the non-private neural network are fixed while performing the first neural network operations;
encrypt the first output data from the non-private neural network using a homomorphic encryption method to produce first encrypted data; and
perform second neural network operations homomorphically using a private neural network of the privacy-preserving neural network model based on the first encrypted data to produce second encrypted data, wherein learnable parameters of the private neural network are trained while performing the second neural network operations.

20.-37. (canceled)

38. The system according to claim 18, wherein the non-private neural network comprises one or more first convolution layers obtained from a pre-trained neural network.
